(19) United States
(12) Patent Application Publication
(10) Pub. No.: US 2009/0116148 A1
(43) Pub. Date: May 7, 2009

(54) HYDRODYNAMIC BEARING DEVICE AND SPINDLE MOTOR EQUIPPED WITH SAME, AND INFORMATION APPARATUS

(76) Inventors: Hisaaki Yano, Ehime (JP); Hiroshi Nishiyama, Manila (PH); Yosei Yoshikawa, Ehime (JP); Kaoru Uenosono, Ehime (JP)

Correspondence Address: WENDEROTH, LIND & PONACK L.L.P., 1030 15th Street, N.W., Suite 400 East, Washington, DC, 20005-1503, US

(21) Appl. No.: 12/259,519

(22) Filed: Oct. 28, 2008

(30) Foreign Application Priority Data
Oct. 31, 2007 (JP) 2007-282704
Mar. 12, 2008 (JP) 2008-063255

(51) Int. Cl. G11B 17/32; F16C 32/06; H02K 5/167

(52) U.S. Cl. 360/224; 384/107; 310/90; G9B/17.061

(57) ABSTRACT

A hydrodynamic bearing device (30) comprises a shaft (31), a sleeve (32) in which the shaft (31) is installed so as to be able to rotate in relative fashion, a lubricant (34) filled into a minute gap between the shaft (31) and the sleeve (32), a sleeve cover (35) attached to the upper end surface of the sleeve (32), a lubricant reservoir (50) for retaining the lubricant (34) between the sleeve (32) and the sleeve cover (35), and flow suppressing parts (51a, 51b) formed inside the lubricant reservoir (50) so as to protrude in an axial direction.

### CROSS-REFERENCE TO RELATED APPLICATIONS

This application claims priority to Japan Patent Application Nos. 2007-282704 and 2008-063255. The entire disclosures of Japan Patent Application Nos. 2007-282704 and 2008-063255 are hereby incorporated herein by reference.

### BACKGROUND OF THE INVENTION

1. Field of the Invention

The present invention relates to a hydrodynamic bearing device mounted in a motor for rotationally driving a magnetic disk, optical disk, or other recording disk or polygon mirror or the like, to a spindle motor equipped with the hydrodynamic bearing device, and to an information apparatus.

2. Description of the Related Art

A hydrodynamic bearing device for utilizing hydrodynamic pressure of oil or another lubricant between a shaft and a sleeve and supporting the shaft and sleeve so that the shaft and sleeve can rotate relative to each other has been proposed in the past as a bearing of a spindle motor used in a recording device to rotationally drive a magnetic disk, optical disk, magneto-optical disk, or other disk-shaped recording medium.

A minute gaps are formed between the shaft and the sleeve, and a hydrodynamic groove (radial hydrodynamic groove) formed along the peripheral direction of a rotary shaft, and a hydrodynamic groove (thrust hydrodynamic groove) formed in the radial direction of the rotary shaft are formed in at least one of the shaft and the sleeve. The oil as the lubricant is retained in the minute gaps. Structures for such a hydrodynamic bearing device include a so-called one side bag structure in which a tapered seal part is formed in the end parts of the minute gaps and exposed to the atmosphere. A structure also exists in which a sleeve cover is placed on the end surface of the sleeve, and the lubricant is retained between the sleeve and the sleeve cover.

In Patent Document 1 (Japanese Laid-open Patent Publication No. 2006-170230), for example, a hydrodynamic bearing device is disclosed in which a sleeve cover is provided to the end surface of the sleeve, and a lubricant reservoir is formed in the gap between the opposing surfaces of the sleeve cover and the upper end surface of the sleeve. According to this hydrodynamic bearing device, the reservoir for retaining the lubricant is formed in the peripheral direction, the size of the axial gap in the vicinity of a ventilation hole communicated with the outside air that is formed in the sleeve cover is maximized, and a tapered seal part is formed, and the volume of the lubricant reservoir can thereby be made larger than in the conventional technique.

An example will be described using the conventional hydrodynamic bearing device 2001 shown in FIGS. 29A and 29B. FIG. 29A is a sectional view showing the conventional hydrodynamic bearing device 2001.

The conventional hydrodynamic bearing device 2001 is provided with a shaft 2002, a sleeve 2003 positioned on the external periphery via a gap with respect to the shaft 2002, a thrust plate 2004 closing one end of the sleeve 2003, and a thrust flange 2005 provided to the end part at one end of the shaft 2002 and positioned in an orientation having a gap with respect to the sleeve 2003 and the thrust plate 2004. A radial bearing 2042 is also formed in the gap between the external peripheral surface of the shaft 2002 and the internal peripheral surface of the sleeve 2003. A lubricant 2006 is filled into the gaps between the radial bearing 2042, both surfaces of the thrust flange 2005 and the end surface of the opposing sleeve 2003, and the end surface of the thrust plate 2004.

A sleeve cover 2007 is positioned so as to cover the end surface on the opening side of the sleeve 2003, and a fluid reservoir 2008 is formed.

A communicating channel 2010 for linking the fluid reservoir 2008 with a space 2009 for forming a thrust bearing is formed in the sleeve 2003, and a structure is formed whereby the lubricant 2006 filled into the gaps of the bearing device can be circulated.

Furthermore, an inclined surface 2011 inclined to the outside in the radial direction from the rotational center axis of the shaft 2002 is formed in the internal peripheral surface of the sleeve cover 2007, and a seal structure for preventing the lubricant 2006 from leaking to the outside is formed between the inclined surface 2011 and the external peripheral surface of the shaft 2002. A ventilation hole 2012 for discharging bubbles and the like from within the bearing is also formed in a position of diagonal 180 degrees from the opening part of the communicating channel 2010 in the end surface on the opening side of the sleeve 2003.

The fluid reservoir 2008 formed between the inside surface of the sleeve cover 2007 and the end surface on the opening side of the sleeve 2003 is a space that is inclined so that the space narrows from the ventilation hole 2012 to the communicating hole 2010.

The manner in which the interface of the lubricant 2006 in the fluid reservoir 2008 moves due to evaporation and the like will be described using FIG. 29B.

The fluid reservoir 2008 is formed so as to be narrowest in the vicinity of the communicating hole 2010 and widest in the vicinity of the ventilation hole 2012. The interface of the lubricant 2006 positioned at the interface 2006o and the interface 2006oo therefore first moves to the interface 2006a and the interface 2006aa due to evaporation at the initial stage of assembly. The interface then moves to the interface 2006b and the interface 2006bb. The interface of the lubricant 2006 thus moves toward the communicating hole 2010 from the ventilation hole 2012.

The interface of the lubricant is thus prevented from moving to the bearing gap in a short time due to evaporation, by increasing the volume of the lubricant 2006 retained in the fluid reservoir 2008.

### SUMMARY OF THE INVENTION

However, the conventional hydrodynamic bearing device described above has such drawbacks as those described below.

Specifically, in the hydrodynamic bearing device disclosed in the abovementioned publication, although an adequate volume of the lubricant reservoir is maintained, there remains a risk of the lubricant leaking out from the ventilation hole due to shock, vibration, or the like when the gas-liquid boundary parts of the lubricant and the air moves near the ventilation hole due to such causes as component precision issues and other non-design factors.

Specifically, in the stationary state of the hydrodynamic bearing device, although the gas-liquid boundary surfaces is formed substantially uniform and symmetrical about the ventilation hole, when the transition to a rotating state occurs, it is apparent that disruption and the like of the circulating flow occurs due to fluctuations in component precision and other factors, and the gas-liquid boundary surfaces sometimes moves irregularly. At such times, when an shock, vibration, or the like is imparted in a state in which the gas-liquid boundary surfaces has moved near the ventilation hole, problems occur in that the lubricant easily leaks from the ventilation hole. The inside of the spindle motor in which the hydrodynamic bearing device is mounted therefore becomes contaminated with lubricant, and there is a risk of such defects as reduced reliability of the device and decreased service life of the bearing due to insufficient lubricant.

An object of the present invention is to provide a hydrodynamic bearing device whereby such problems as decreased service life or reduced reliability due to leakage of the lubricant can be prevented from occurring in a hydrodynamic bearing device that employs a structure for retaining the lubricant between the sleeve and the sleeve cover, and to provide an information apparatus and a spindle motor provided with the hydrodynamic bearing device.

The hydrodynamic bearing device according to a first aspect of the present invention comprises a shaft, a sleeve, a lubricant, a sleeve cover, a lubricant reservoir, and a flow suppressing part. The shaft is inserted in the sleeve so as to be able to rotate relative to the sleeve. The lubricant is filled into a gap between the shaft and the sleeve. The sleeve cover is attached so as to cover a surface on one end of the sleeve in the axial direction via a gap, and has a ventilation hole for communicating the lubricant with outside air. The lubricant reservoir retains the lubricant in the gap between the sleeve and the sleeve cover. The flow suppressing part is formed inside the lubricant reservoir in the gap between the sleeve and the sleeve cover so as to suppress movement of the lubricant in the peripheral direction.

In the hydrodynamic bearing device comprising the lubricant reservoir for retaining the lubricant in the gap between one surface of the sleeve in the axial direction and the sleeve cover having the ventilation hole that is attached so as to cover the one side of the sleeve, the flow suppressing part protruding in the axial direction or the radial direction is provided in the gap between the sleeve and the sleeve cover.

The flow suppressing part is pillar-shaped members extending in the axial direction or the radial direction, for example, and are provided in order to regulate the movement of the gas-liquid boundary between the lubricant (liquid region) retained in the lubricant reservoir and the air area (air region) present in the immediate vicinity of the ventilation hole in the inside of the lubricant reservoir during rotation of the hydrodynamic bearing device. It is thus sufficient insofar as the flow suppressing part is provided in the lubricant somewhat outside the gas-liquid boundary formed on the left and right of the ventilation hole in the peripheral direction about the shaft, for example.

Movement of the gas-liquid boundary surfaces of the lubricant to the immediate vicinity of the ventilation hole can thereby be suppressed due to surface tension of the lubricant that occurs around the flow suppressing part even when the position of the air area centered around the ventilation hole moves or extends in the peripheral direction after transition of the hydrodynamic bearing device from the static state to the rotating state. As a result, even when vibration or shock is imparted to the hydrodynamic bearing device, the lubricant is prevented from leaking out from the ventilation hole, and such defects as reduced service life due to outside contamination of the hydrodynamic bearing device or insufficient lubricant can be prevented from occurring.

The hydrodynamic bearing device according to a second aspect of the present invention is the hydrodynamic bearing device according to the first aspect, wherein the lubricant reservoir is formed in a gap in the axial direction between the sleeve and the sleeve cover, and the flow suppressing part is formed so as to protrude in substantially the axial direction.

In this arrangement, pillar-shaped convex part, for example, is used as the flow suppressing part, and are positioned opposite each other in the axial direction and formed so as to protrude to the opposing surface from any one or both of the sleeve cover and the sleeve.

The flow suppressing part for suppressing the movement of the gas-liquid boundary surfaces of the lubricant in the peripheral direction can thereby be provided in a simple configuration.

The hydrodynamic bearing device according to a third aspect of the present invention is the hydrodynamic bearing device according to the first aspect, wherein the lubricant reservoir is formed in a gap in a radial direction between an internal peripheral surface of the sleeve cover and an external peripheral surface of the surface on one side of the sleeve, and the flow suppressing part is formed so as to protrude in substantially the radial direction.

In this arrangement, pillar-shaped convex part, for example, is used as the flow suppressing parts, and are positioned opposite each other in the radial direction and formed so as to protrude to the opposing side from any one or both of the sleeve cover and the sleeve.

The flow suppressing part for suppressing the movement of the gas-liquid boundary surfaces of the lubricant in the peripheral direction can thereby be provided in a simple configuration.

The hydrodynamic bearing device according to a fourth aspect of the present invention is the hydrodynamic bearing device according to the first aspect, wherein the flow suppressing part is formed so as to include a convex part that protrudes toward an opposing surface of the sleeve from the sleeve cover.

In this arrangement, pillar-shaped convex parts, for example, is used as the flow suppressing part, and are formed so as to protrude to the opposing surface of the sleeve from the side of the sleeve cover.

The convex parts may extend until reaching the surface of the opposing sleeve, or may extend to the extent that a minute gap is provided.

The flow suppressing part for suppressing the movement of the gas-liquid boundary surfaces of the lubricant in the peripheral direction can thereby be provided in a simple configuration.

The hydrodynamic bearing device according to a fifth aspect of the present invention is the hydrodynamic bearing device according to the first aspect, wherein the flow suppressing part is formed so as to include a convex part that protrudes toward the opposing sleeve cover from the surface of the sleeve.

In this arrangement, pillar-shaped convex parts, for example, formed so as to protrude to the opposing surface of the sleeve cover from the side of the sleeve, or a combination with convex parts protruding from the sleeve cover side is used as the flow suppressing part.

The convex parts may extend until reaching the surface (or convex part) of the opposing sleeve cover, or may extend to the extent that a small gap is provided.

The flow suppressing part for suppressing the movement of the gas-liquid boundary surfaces of the lubricant in the peripheral direction can thereby be provided in a simple configuration.

The hydrodynamic bearing device according to a sixth aspect of the present invention is the hydrodynamic bearing device according to the first aspect, wherein the flow suppressing part is positioned on left and right sides of the ventilation hole in a peripheral direction around the central axis of rotation.

The flow suppressing part provided for restricting movement of the air-fluid boundary in the peripheral direction is positioned on the left and right sides of the ventilation hole in the peripheral direction.

The flow suppressing part positioned in left-right symmetry may be configured so that one each thereof is provided on the left and the right, or a plurality thereof may be provided on each of the left and right.

Movement of the position of the gas-liquid boundary surfaces to the position directly below the ventilation hole can thereby be more effectively suppressed during the transition of the hydrodynamic bearing device to the rotating state, even when the air area moves or extends in the peripheral direction.

The hydrodynamic bearing device according to a seventh aspect of the present invention is the hydrodynamic bearing device according to the sixth aspect, wherein the flow suppressing part positioned on left and right sides of the ventilation hole is positioned at substantially equal angles from the ventilation hole.

In this arrangement, the flow suppressing part positioned on the left and right of the ventilation hole in the peripheral direction is positioned at substantially equal angles so as to be substantially even on the left and right.

The flow suppressing parts positioned in left-right symmetry may be configured so that one each thereof is provided on the left and the right, or a plurality thereof may be provided on each of the left and right.

Even when it is impossible to identify the movement direction or extension direction of the air area due to the rotation direction of the rotation side of the hydrodynamic bearing device, the size of the gap of the lubricant reservoir, and various other conditions, placing the flow suppressing parts at equal angles on the left and right of the ventilation hole makes it possible to effectively suppress movement of the gas-liquid boundary surfaces.

The hydrodynamic bearing device according to an eighth aspect of the present invention is the hydrodynamic bearing device according to the second aspect, wherein the flow suppressing part is positioned in a substantially central portion in the radial direction inside the lubricant reservoir.

In this arrangement, the abovementioned flow suppressing part is positioned in the substantial center in the radial direction about the central axis of rotation.

Movement of the gas-liquid boundary surfaces can thereby be effectively suppressed by the flow suppressing part positioned substantially in the center in the radial direction in the lubricant reservoir, even when the air area around the ventilation hole moves or extends.

The hydrodynamic bearing device according to a ninth aspect of the present invention is the hydrodynamic bearing device according to the third aspect, wherein the flow suppressing parts are positioned in a substantially central portion in the axial direction inside the lubricant reservoir.

In this arrangement, the abovementioned flow suppressing part is positioned in the substantial center in the radial direction about the central axis of rotation.

Movement of the gas-liquid boundary surfaces can thereby be effectively suppressed by the flow suppressing part positioned substantially in the center in the axial direction in the lubricant reservoir, even when the air area around the ventilation hole moves or extends.

The hydrodynamic bearing device according to a tenth aspect of the present invention is the hydrodynamic bearing device according to the second aspect, wherein the flow suppressing part is formed without a gap in the axial direction in the gap between the sleeve and the sleeve cover.

In this arrangement, the flow suppressing part is formed without a gap in the axial direction in the gap between the opposing surfaces of the sleeve and the sleeve cover.

Movement of the gas-liquid boundary surfaces thereby can be more effectively suppressed by the flow suppressing part provided without a gap in the axial direction, even when the air area moves or extends in the peripheral direction.

The hydrodynamic bearing device according to an eleventh aspect of the present invention is the hydrodynamic bearing device according to the third aspect, wherein the flow suppressing part is formed without a gap in the radial direction in the gap between the sleeve and the sleeve cover.

In this arrangement, the flow suppressing part is formed without a gap in the radial direction in the gap between the opposing surfaces of the sleeve and the sleeve cover.

Movement of the gas-liquid boundary surfaces thereby can be more effectively suppressed by the flow suppressing part provided without a gap in the radial direction, even when the air area moves or extends in the peripheral direction.

The hydrodynamic bearing device according to a twelfth aspect of the present invention is the hydrodynamic bearing device according to the first aspect, wherein the flow suppressing part includes a block-shaped member extending in the peripheral direction.

In this arrangement, block-shaped members formed in the peripheral direction about the central axis of rotation are used as the flow suppressing members.

The magnitude of the surface tension generated by forming the flow suppressing part is thereby increased, and movement of the gas-liquid boundary surfaces can be more effectively suppressed than in a case in which pillar-shaped members are used as the flow suppressing part.

The hydrodynamic bearing device according to a thirteenth aspect of the present invention is the hydrodynamic bearing device according to the second aspect, wherein the lubricant reservoir is formed so that a gap in the axial direction decreases in the peripheral direction from a maximum size in a vicinity of the ventilation hole.

In this arrangement, a tapered seal part is formed for varying the gap in the peripheral direction about the ventilation hole.

Since the size of the gap thereby decreases in the peripheral direction from the largest gap size at the ventilation hole, the lubricant can be guided in the direction away from the ventilation hole by capillary force of the lubricant. As a result, the lubricant can be effectively prevented from leaking out from the ventilation hole.

The hydrodynamic bearing device according to a fourteenth aspect of the present invention is the hydrodynamic bearing device according to the third aspect, wherein the lubricant reservoir is formed so that a gap in the radial direction decreases in the peripheral direction from a maximum size in a vicinity of the ventilation hole.

In this arrangement, a tapered seal part is formed for varying a size of the gap in the peripheral direction about the ventilation hole.

Since the size of the gap thereby decreases in the peripheral direction from the largest gap size at the ventilation hole, the lubricant can be guided in the direction away from the ventilation hole by capillary force of the lubricant. As a result, the lubricant can be effectively prevented from leaking out from the ventilation hole.

The hydrodynamic bearing device according to a fifteenth aspect of the present invention is the hydrodynamic bearing device according to the thirteenth aspect, wherein the flow suppressing part is formed in positions in which the gap is larger than an average size of the gap in the axial direction in the lubricant reservoir.

In this arrangement, the flow suppressing part is formed in portions in which the gap is larger than the average size of the gap in the axial direction in the lubricant reservoir that includes the tapered seal part formed so that the gap in the axial direction varies in order to retain the lubricant.

Movement of the gas-liquid boundary surfaces can thereby be effectively suppressed by providing the flow suppressing part in positions in which the gas-liquid boundary surfaces moves easily as the gap is relatively large.

The hydrodynamic bearing device according to a sixteenth aspect of the present invention is the hydrodynamic bearing device according to the fourteenth aspect, wherein the flow suppressing part is formed in positions in which the gap is larger than an average size of the gap in the radial direction in the lubricant reservoir.

In this arrangement, the flow suppressing part is formed in portions in which the gap is larger than the average size of the gap in the radial direction in the lubricant reservoir that includes the tapered seal part formed so that the gap in the radial direction varies in order to retain the lubricant.

Movement of the gas-liquid boundary surfaces can thereby be effectively suppressed by providing the flow suppressing part in positions in which the gas-liquid boundary surfaces moves easily as the gap is relatively large.

The hydrodynamic bearing device according to a seventeenth aspect of the present invention is the hydrodynamic bearing device according to the first aspect, wherein the sleeve has a closed end surface, a first space is formed between the sleeve cover and the end surface on one side of the sleeve, and a second space is formed on the side of the closed end surface inside the bearing hole in the sleeve. A communicating channel for communicating the first space and the second space is also formed inside the sleeve or on the sleeve, a radial bearing is formed between an external peripheral surface of the shaft and an internal peripheral surface of the sleeve, and an introduction gap is formed from a vicinity of an open part of the communicating channel in the first space to an open end of the bearing hole.

In this arrangement, the lubricant reservoir is formed so that a cross-sectional area of the first space gradually decreases in size in the peripheral direction from the ventilation hole to the open part of the communicating channel. The flow suppressing part is positioned on an opposite side in the peripheral direction from the lubricant reservoir so as to sandwich the ventilation hole. The flow suppressing part is also formed so as to rapidly reduce a size of the cross-sectional area of the first space in the peripheral direction from the ventilation hole to the open part of the communicating channel.

Since the capillary force of the lubricant reservoir and the capillary force in the flow suppressing part is thereby balanced even when the interface of the lubricant on the side of the lubricant reservoir tends toward movement in the peripheral direction, there is almost no movement of the interface on the side of the flow suppressing part. As a result, it is possible to suppress movement of the gas-liquid boundary surfaces of the lubricant to the immediate vicinity of the ventilation hole. As a result, the lubricant is prevented from leaking out from the ventilation hole even when vibration or shock is imparted to the hydrodynamic bearing device, and such defects as reduced service life due to outside contamination of the hydrodynamic bearing device or insufficient lubricant can be prevented from occurring.

The hydrodynamic bearing device according to an eighteenth aspect of the present invention comprises a sleeve, a shaft, a sleeve cover, a first space, a second space, a communicating hole, a lubricant, a radial bearing, a thrust bearing, an introduction gap, a ventilation hole, a first lubricant reservoir, and a second lubricant reservoir. The sleeve has a bearing hole that has an open end and a closed end. The shaft is inserted in a state of being able to rotate via a gap inside the bearing hole. The sleeve cover is attached so as to cover the end surface on the open end side of the sleeve. The first space is formed between the sleeve cover and the end surface on the side of the open end. The second space is formed on the side of the closed end surface inside the bearing hole in the sleeve. The communicating channel is formed in the sleeve, and communicates the first space and the second space. The lubricant is filled into a gap between the sleeve cover, the sleeve, and the shaft. The radial bearing is formed between an external peripheral surface of the shaft and an internal peripheral surface of the sleeve. The thrust bearing is formed between an end surface inside the closed end of the sleeve and the end surface of the shaft on the side of the closed end of the sleeve. The introduction gap is formed from a vicinity of the open part of the communicating channel to an open end of the bearing hole in the first space. The ventilation hole is formed in the sleeve cover and communicates the first space with outside air. In the first lubricant reservoir, a cross-sectional area of the first space gradually decreases in the peripheral direction toward the open part of the communicating channel from the ventilation hole. In the second lubricant reservoir, a cross-sectional area of the first space rapidly decreases in size in the peripheral direction toward the open part of the communicating channel from the ventilation hole.

Since the capillary forces of the first and second lubricant reservoirs thereby balance each other, there is almost no movement of the interface on the side of the second fluid suppressing part even when the interface of the lubricant on the side of the first lubricant reservoir tends toward movement in the peripheral direction. Movement of the gas-liquid boundary surfaces of the lubricant to the immediate vicinity of the ventilation hole can even be suppressed on the side of the first lubricant reservoir by the anchoring effect on the side of the second flow suppressing part. As a result, the lubricant is prevented from leaking out from the ventilation hole even when vibration or shock is imparted to the hydrodynamic bearing device, and such defects as reduced service life due to outside contamination of the hydrodynamic bearing device or insufficient lubricant can be prevented from occurring.

The hydrodynamic bearing device according to a nineteenth aspect of the present invention is the hydrodynamic bearing device according to the eighteenth aspect, wherein the first lubricant reservoir and the second lubricant reservoir are formed by an inclined surface provided to the sleeve cover. The inclined surface for forming the first lubricant reservoir has a tilt angle of 5 to 7 degrees with respect to the end surface on the open side of the sleeve, and the inclined surface for forming the second lubricant reservoir has a tilt angle of 50 to 70 degrees with respect to the end surface on the open side of the sleeve.

The hydrodynamic bearing device according to a twentieth aspect of the present invention is the hydrodynamic bearing device according to the eighteenth aspect, wherein a blocking part for blocking a flow of the lubricant in the peripheral direction from the ventilation hole to the vicinity of the open part of the communicating channel is formed in the second lubricant reservoir.

The spindle motor according to a twenty-first aspect of the present invention comprises the hydrodynamic bearing device according to the first aspect, a hub attached to a rotation side of the hydrodynamic bearing device, a rotary magnet attached to the hub, and a stator coil for imparting rotational force to the rotary magnet.

The information apparatus according to a twenty-second aspect of the present invention comprises the spindle motor according to the twenty-first aspect, and a head part for performing recording and reproducing of a recording disk that is rotationally driven by the spindle motor.

The spindle motor according to a twenty-third aspect of the present invention comprises the hydrodynamic bearing device according to the eighteenth aspect, a hub attached to a rotation side of the hydrodynamic bearing device, a rotary magnet attached to the hub, and a stator coil for imparting rotational force to the rotary magnet.

The information apparatus according to a twenty-fourth aspect of the present invention comprises the spindle motor according to the twenty-third aspect, and a head part for performing recording and reproducing of a recording disk that is rotationally driven by the spindle motor.

### BRIEF DESCRIPTION OF THE DRAWINGS

FIG. 1 is a sectional view showing the structure of the spindle motor in which the hydrodynamic bearing device of Embodiment 1 of the present invention is mounted;

FIG. 2 is an enlarged sectional view showing the structure of the hydrodynamic bearing device mounted in the spindle motor shown in FIG. 1;

FIG. 3 is a plan view showing the vicinity of the lubricant reservoir as viewed from the side of the sleeve cover in the hydrodynamic bearing device shown in FIG. 2;

FIG. 4 is a partial sectional view showing the structure of the area around the lubricant reservoir formed in the gap between the sleeve cover and the upper end surface of the main body portion of the sleeve in FIG. 3;

FIG. 5 is a sectional development view in which the lubricant reservoir shown in FIG. 4 is developed in the peripheral direction along line C in FIG. 3;

FIGS. 6A through 6C are plan views showing a state in which the air region (air area) has moved in the peripheral direction inside the fluid reservoir shown in FIG. 5 and other diagrams;

FIGS. 7A through 7C are plan views showing a state in which the air region (air area) has moved in the peripheral direction inside the fluid reservoir shown in FIG. 5 and other diagrams;

FIG. 8 is a partial enlarged view of the sectional development view of FIG. 5;

FIG. 9 is a partial plan view showing the hydrodynamic bearing device in order to describe the principle of suppressing movement of the gas-liquid boundary surfaces in the hydrodynamic bearing device;

FIGS. 10A and 10B are a plan view and a peripheral-direction sectional development view, respectively, showing a state in which the air-fluid boundary has moved in the peripheral direction in the hydrodynamic bearing device;

FIGS. 11A and 11B are partial plan views showing the hydrodynamic bearing device in order to describe the movement state of the gas-liquid boundary surfaces in the hydrodynamic bearing device;

FIG. 12 is a plan view showing the structure of the hydrodynamic bearing device according to another embodiment of the present invention;

FIG. 13 is a plan view showing the structure of the hydrodynamic bearing device according to yet another embodiment of the present invention;

FIG. 14 is a plan view showing the structure of the hydrodynamic bearing device according to yet another embodiment of the present invention;

FIG. 15 is a sectional view showing a portion of the structure of the hydrodynamic bearing device according to yet another embodiment of the present invention;

FIG. 16 is a plan view showing the structure of the hydrodynamic bearing device shown in FIG. 15;

FIG. 17 is a sectional view showing a portion of the structure of the hydrodynamic bearing device according to yet another embodiment of the present invention;

FIG. 18 is a plan view showing the structure of the hydrodynamic bearing device according to yet another embodiment of the present invention;

FIG. 19 is a side view showing the structure of a magnetic recording and reproducing apparatus in which the spindle motor including the hydrodynamic bearing device of the present invention is mounted;

FIG. 20 is a sectional view showing the structure of the hydrodynamic bearing device according to yet another embodiment of the present invention;

FIGS. 21A and 21B are a sectional view and a plan view, respectively, showing the structure of the hydrodynamic bearing device according to yet another embodiment of the present invention;

FIG. 22 is a side view showing the structure of the hydrodynamic bearing device according to yet another embodiment of the present invention;

FIG. 23 is a sectional view showing the spindle motor in Embodiment 2 of the present invention;

FIG. 24 is a sectional view showing the hydrodynamic bearing device in Embodiment 2 of the present invention;

FIG. 25A is a plan view of the lubricant reservoir in Embodiment 2 of the present invention as viewed from the side of the sleeve cover, and FIG. 25B is a development view of the lubricant reservoir;

FIGS. 26A, 26B, and 26C are diagrams showing the state of the lubricant of the lubricant reservoir in Embodiment 2 of the present invention;

FIG. 27 is a sectional view showing the interface of the lubricant in the lubricant reservoir in Embodiment 2 of the present invention;

FIG. 28A is a plan view showing the lubricant reservoir as viewed from the side of the sleeve cover in another embodiment, and FIG. 28B is a development view showing the lubricant reservoir; and

FIG. 29A is a sectional view showing the conventional hydrodynamic bearing device, and FIG. 29B is a plan view showing the lubricant reservoir as viewed from the side of the sleeve cover.

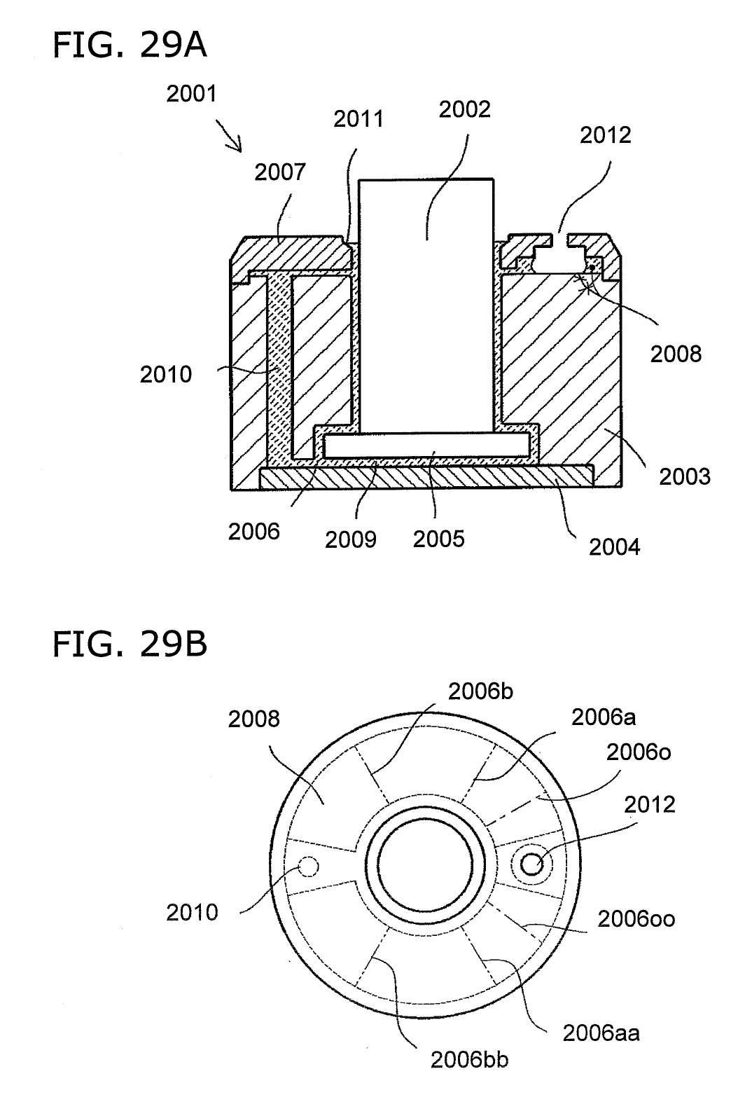

### DETAILED DESCRIPTION OF THE INVENTION

### Embodiment 1

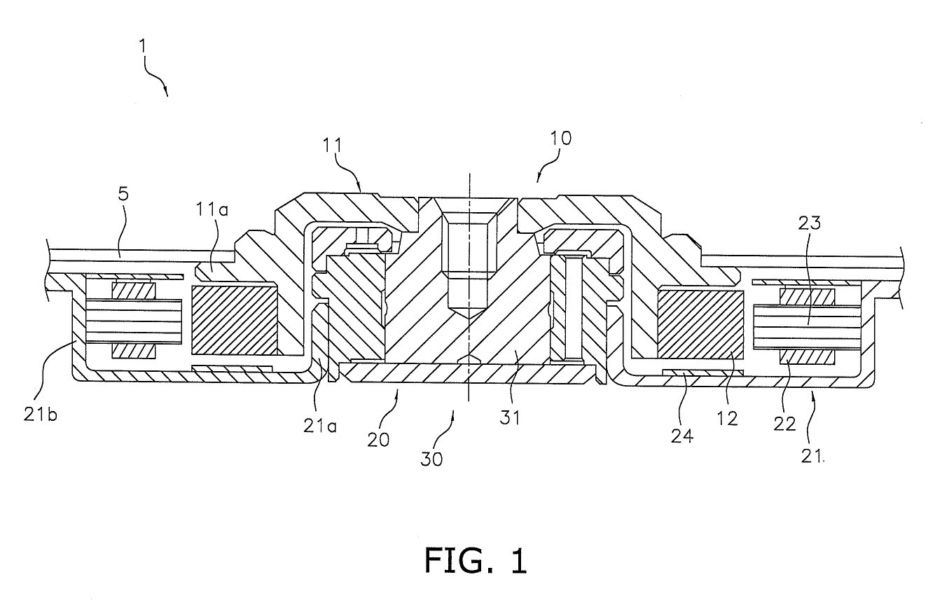

The spindle motor 1 in which the hydrodynamic bearing device 30 according to an embodiment of the present invention is mounted is as described hereinafter using FIGS. 1 through 9.

In the description given hereinafter, the vertical direction in FIG. 1 is expressed as the “axial direction,” but this description does not limit the direction in which the hydrodynamic bearing device 30 is actually attached.

[Structure of the Spindle Motor 1]

The spindle motor 1 of the present embodiment as shown in FIG. 1 is a device for rotationally driving a disk-shaped recording disk (recording medium) 5, and primarily comprises a rotary member 10, a static member 20, and the hydrodynamic bearing device 30.

The rotary member 10 primarily has a hub 11 to which the recording disk 5 is mounted, and a rotor magnet (rotary magnet) 12.

The hub 11 has a hollow cylinder shape that has a top surface, and is formed by stainless steel (e.g., DHS1) as an iron-based metal material, for example. The hub 11 is also integrated with a shaft 31 by press-fitting or the like with respect to the shaft 31. The shaft 31 has a circular cylindrical shape, and is formed by stainless steel (e.g., SUS420, SUS303) as an iron-based metal material. A flange-shaped disk mounting part 11a for mounting the recording disk 5 is integrally formed with the external peripheral part of the hub 11.

The rotor magnet 12 has an annulus shape, is fixed to the surface on the external peripheral side of the downward-hanging cylindrical part from the flange part of the hub 11, and constitutes a magnetic circuit with a stator core 23 onto which a coil (stator coil) 22 described hereinafter is wound. In the present embodiment, the external peripheral surface facing the stator is multipolar magnetized. The rotor magnet 12 is formed by a Ne—Fe—B based resin magnet or other high-energy product magnet material. Furthermore, the rotor magnet 12 is subjected to an epoxy resin coating, electrodeposition coating, nickel plating, or the like applied to the surface thereof for anti-rust treatment or chip-prevention treatment.

The recording disk 5 is mounted on the disk mounting part 11a; for example, a disk-shaped clamper or the like (not shown) having spring properties in the axial direction is set in a tapping screw (not shown), and the tapping screw is screwed into a screw tap part provided in the center of the shaft 31, whereby the recording disk 5 is pressed downward in the axial direction and held between the clamper and the disk mounting part 11a.

The static member 20 is primarily composed of a base 21, a sleeve 32 fixed to the base 21, and a stator core 23 onto which a coil 22 is wound, the stator core 23 also being fixed to the base 21, as shown in FIG. 1.

The base 21 used as the housing of the information apparatus has a cylindrical first base part 21a that protrudes from the base 21 as the base portion of the hydrodynamic bearing device 30 described hereinafter, and a second base part 21b for attaching the stator core 23 onto which the coil 22 is wound. The base 21 is formed by a non-magnetic aluminum-based metal material (e.g., ADC12) or a magnetic iron-based metal material (e.g., SPCC, SPCD). When the base 21 is a non-magnetic material, a separate attracting plate formed by a magnetic material may be provided in a position opposite the end surface of the rotor magnet 12.

The stator core 23 onto which the coil 22 is wound is fixed to the second base part 21b, and the internal peripheral part thereof is positioned facing the external peripheral part of the rotor magnet 12 so as to maintain a predetermined gap. A plurality of salient poles oriented toward the internal periphery is formed in the stator core 23, and a coil 22 is wound onto each of the salient poles. The stator core 23 is formed by layering silicon steel plates having a thickness of 0.15 to 0.35 mm (primarily 0.15, 0.2, and 0.35 mm).

[Detailed Structure and Other Aspects of the Hydrodynamic Bearing Device 30]

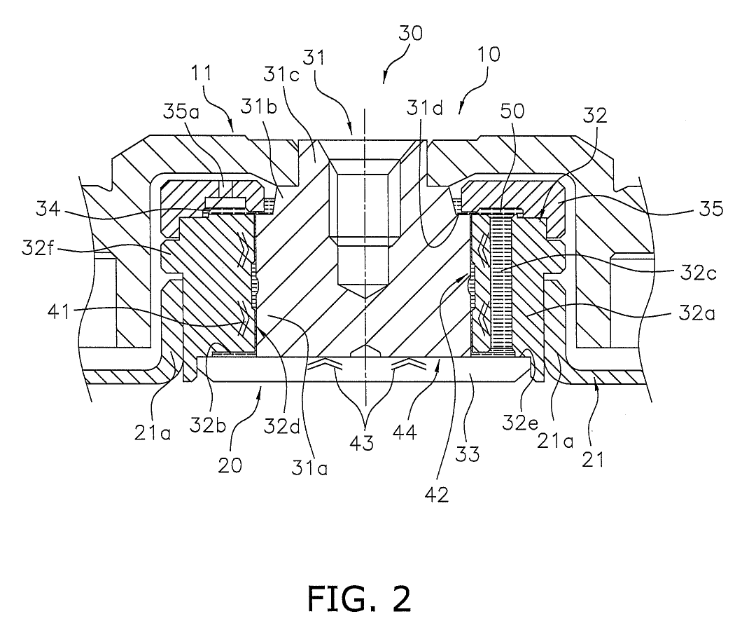

The hydrodynamic bearing device 30 is primarily configured so as to include the shaft 31, the sleeve 32, a thrust plate 33, and a lubricant 34, and as shown in FIG. 2, the hydrodynamic bearing device 30 is fixed to the first base part 21a, which is an open part formed in substantially the center of the base 21, and supports the rotary member 10 in a rotatable state with respect to the static member 20. When the hydrodynamic bearing device 30 is viewed in detail, the sleeve 32 and the thrust plate 33 constitute static-side members, and the shaft 31 constitutes a rotating-side member.

The shaft 31 is a circular-cylinder-shaped member extending in the axial direction, which is formed by stainless steel (e.g., SUS420, SUS303), manganese chromium steel (e.g., ASK8000), ceramic, or the like as an iron-based metal material, and is inserted in a bearing hole 32d of the sleeve 32 so as to be able to rotate. Specifically, the shaft 31 is positioned so as to be capable of rotating relative to the sleeve 32 and the thrust plate 33 via a gap. The shaft 31 also has a main body part 31a; a small-diameter part 31b having a smaller diameter than the main body part 31a, on the outside in the axial direction adjacent to the main body part 31a; and a slim-diameter part 31c having an even smaller diameter than the small-diameter part 31b, in the vicinity of the outside end part of the shaft 31. A shoulder part 31d that is a surface parallel to the radial direction of the shaft 31 is also formed between the external peripheral surface of the small-diameter part 31b and the external peripheral surface of the main body part 31a in the shaft.

The sleeve 32 is a hollow cylindrical member having a bearing hole 32d extending in the axial direction, is formed by stainless steel, a metal alloy, a sintered metal, or the like, for example, and is fixed with respect to the base 21. The sleeve 32 may also be composed of a combination of a plurality of components, such as a configuration in which a cylindrical sleeve is placed in a cylindrical sleeve holder that has a bottom, for example. Besides the bearing hole 32d opposite the external peripheral surface of the main body part 31a of the shaft 31, a communicating hole 32c for communicating the lower end surface and upper end surface of the sleeve main body part 32a may also be provided to the sleeve 32. A first recess portion 32e for installing the thrust plate 33 (described hereinafter) for closing one side of the sleeve 32 is also provided. Furthermore, a second recess portion 32b is provided to the lower end part of the communicating hole 32c so that the communicating hole 32c is not closed by the thrust plate 33, and so as to enable communication with the bearing hole 32d. Furthermore, a flange part 32f for attaching and fixing a sleeve cover 35 (described hereinafter) is provided to the external peripheral part of the sleeve main body part 32a.

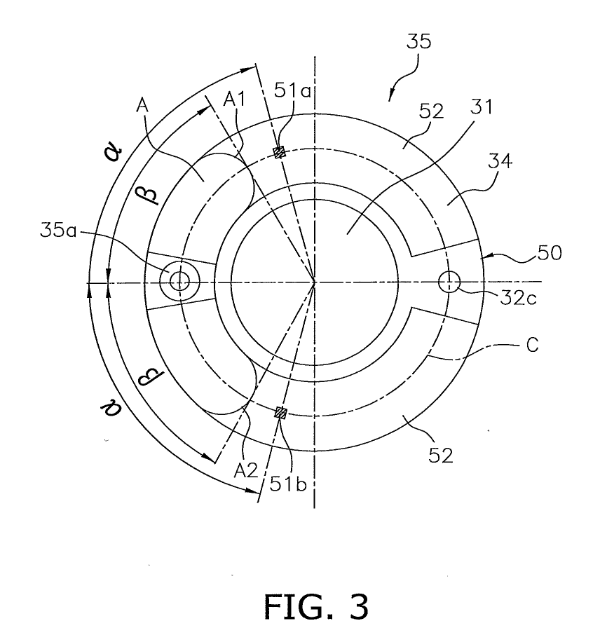

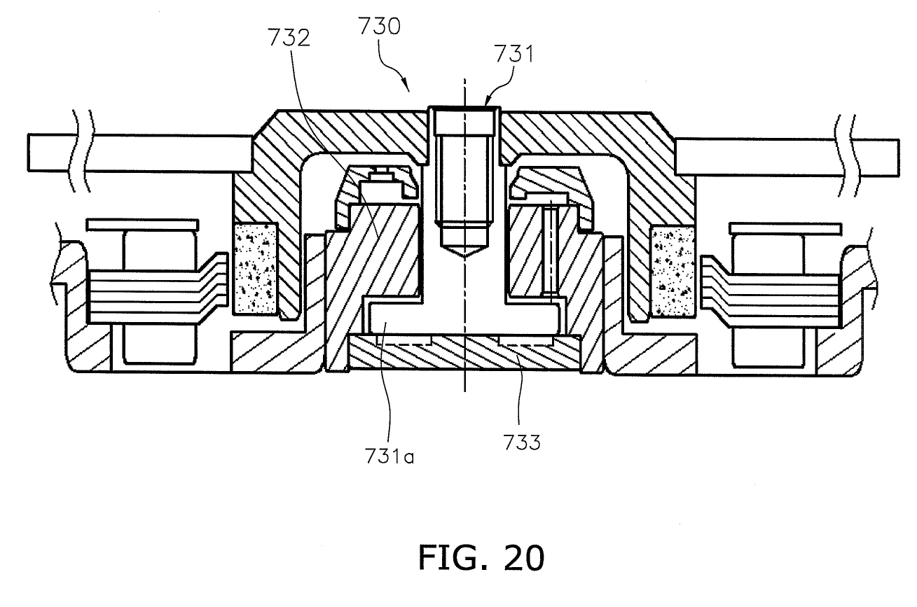

The sleeve cover 35 is a member for forming a lubricant reservoir 50 in the gap formed with the upper end surface of the sleeve 32. The sleeve cover 35 is also a retaining member for preventing the shaft 31 from coming outward in the axial direction, and is a cylindrical member having a smaller inner diameter than the outer diameter of the sleeve main body part 32a. A structure is described herein in which the sleeve cover 35 is used as a retaining member, but a hydrodynamic bearing device 730 may also be formed that employs a structure in which a flange 731a is provided to the shaft 731, and a thrust hydrodynamic bearing is formed between the flange 731a and the sleeve 732, or between the flange 731a and a thrust plate 733, as shown in FIG. 20, and the flange 731a is made to function as a retaining member. A lubricant reservoir 50 in which the depth in the peripheral direction gradually varies is formed in the sleeve cover 35, and a ventilation hole 35a is formed in the deepest part in the axial direction thereof. Through this structure, it is possible for bubbles formed in the lubricant reservoir 50 to be positioned near the ventilation hole 35a regardless of the orientation of the hydrodynamic bearing device. The structure also has the ventilation hole 35a and flow suppressing parts 51a, 51b positioned to the left and right in the peripheral direction of the ventilation hole 35a (see FIGS. 3 through 5 and other diagrams). The structure of the area surrounding the lubricant reservoir 50 that includes the ventilation hole 35a and the flow suppressing parts 51a, 51b will be described in a later section. The sleeve cover 35 is formed by a translucent resin (e.g., polyetherimide resin). This is necessary in order to properly manage the amount of the lubricant filled into the lubricant reservoir 50, and is a characteristic feature of this basic structure (see Patent Document 1). The internal peripheral surface of the sleeve cover 35 is also positioned so as to face the external peripheral side of the small-diameter part 31b of the shaft 31, and forms an open part in which the gas-liquid boundary surfaces is formed inside.

The communicating hole 32c is a hole for communicating the lower end surface and upper end surface of the sleeve main body part 32a as previously described, and is provided so as to circulate the lubricant through the circulating force created by asymmetrical hydrodynamic grooves in the axial direction that are formed by plastic working or the like on the internal peripheral surface of the bearing hole 32d of the sleeve 32. Bubbles and the like can thereby be rapidly discharged from the ventilation hole 35a.

The thrust plate 33 is formed by stainless steel (e.g., SUS420) or carbide alloy steel (e.g., FB10) as an iron-based metal material, and is positioned so as to block a substantially circular open part formed in the bottom end of the sleeve 32 in the axial direction. The thrust plate 33 is manufactured by first punching a blank by pressing or the like, and polishing the blank. A hydrodynamic groove is formed by etching or the like, for example, of the polished blank, and DLC coating or the like is then applied as needed to complete the thrust plate 33.

The parts composed of the rotary member 10 and the static member 20 will next be described.

Herringbone-shaped radial hydrodynamic grooves 41 publicly known in the technical field are formed on the internal peripheral surface of the sleeve main body part 32a, and thrust hydrodynamic grooves 43 are formed on the upper surface (surface opposite the shaft 31) of the thrust plate 33. A radial bearing 42 that includes the radial hydrodynamic grooves 41 is therefore formed between the sleeve 32 and the main body part 31a of the shaft 31. A thrust bearing 44 that includes the thrust hydrodynamic grooves 43 is also formed between the thrust plate 33 and the shaft 31.

The hub 11 is fixed to the external peripheral surface of the slim-diameter part 31c by press fitting, adhesion, laser welding, or the like, and is structured so as to rotate together with the shaft 31.

The lubricant 34 is filled into the communicating hole 32c and the gap formed between the thrust plate 33, the sleeve 32, and the shaft 31 that includes the radial bearing 42 and the thrust bearing 44. At the beginning of manufacturing, the lubricant 34 is filled into the lubricant reservoir formed in the sleeve cover 35 excluding the vicinity of the ventilation hole 35a (The lubricant 34 is excluded from the vicinity of the ventilation hole 35a so that the lubricant 34 does not leak out from the ventilation hole 35a when an shock is imparted, and so that the lubricant 34 does not expand and leak out when the temperature changes). A low-viscosity ester oil, ionic fluid, or the like, for example, can be used as the lubricant 34.

[Structure of the Area Around the Lubricant Reservoir 50]

In the present embodiment, the lubricant reservoir 50 is formed in the gap between the sleeve cover 35 and the upper end surface of the sleeve main body part 32a, as shown in FIGS. 3 through 5.

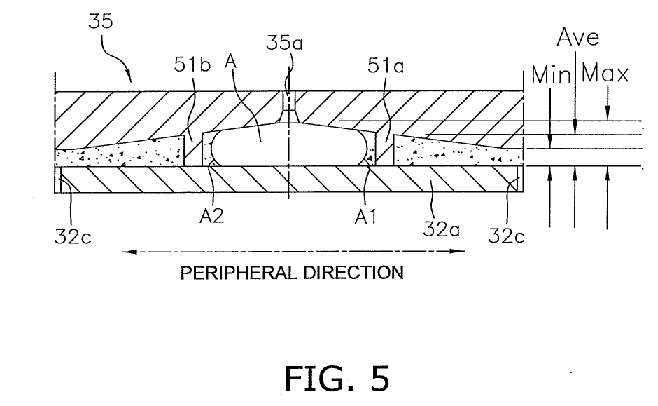

The lubricant reservoir 50 as shown in FIG. 5, has a maximum gap at the position in which the ventilation hole 35a is formed, and the gap gradually narrows away from the ventilation hole 35a in the peripheral direction to the left and right. The lubricant reservoir 50 has a minimum gap near the communicating hole 32c farthest away from the ventilation hole 35a in the peripheral direction. A tapered seal part in which the depth in the axial direction tapers off along the peripheral direction is thereby formed within the lubricant reservoir 50, and surface tension can be created that draws the lubricant 34, which is near the ventilation hole 35a communicated with the outside air, away from the ventilation hole 35a in the peripheral direction. The gas-liquid boundary surfaces that is the boundary of the lubricant 34 and the air is thereby no longer moved by the effects of gravity or the like regardless of changes in the orientation of the hydrodynamic bearing device 30. Leakage of the lubricant 34 from the ventilation hole 35a can also be suppressed.

(Flow Suppressing Parts 51a, 51b)

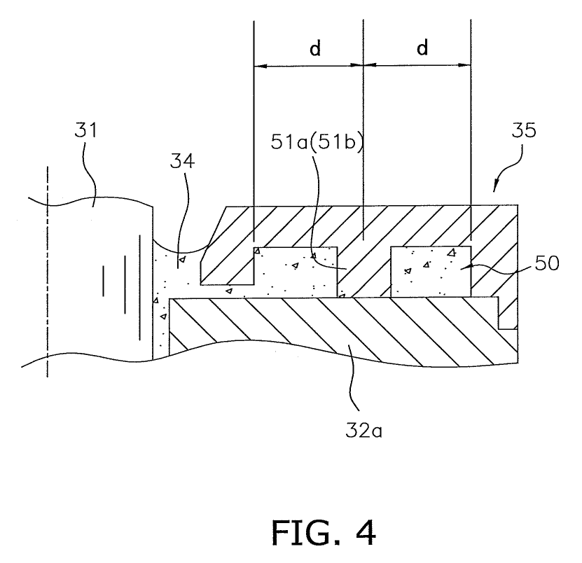

Flow suppressing parts 51a, 51b that protrude from the inward-facing surface of the sleeve cover 35 to the upper end surface of the opposing sleeve main body part 32a are provided in the space of the lubricant reservoir 50 as shown in FIG. 4.

The flow suppressing parts 51a, 51b are pillar-shaped (e.g., circular cylinders or angled cylinders) members protruding from the abovementioned sleeve cover 35 so as to come in contact with the upper end surface of the opposing sleeve main body part 32a as shown in FIG. 4, and are provided to suppress peripheral-direction movement of the air-liquid boundaries A1, A2 between the lubricant 34 and the air A described hereinafter. The principle by which movement of the air-liquid boundaries is suppressed will be described in detail in a later section.

The flow suppressing parts 51a, 51b are positioned at substantially equal angles in the peripheral direction to the left and right of the ventilation hole 35a of the sleeve cover 35, as shown in FIG. 3. The peripheral direction referred to above is the peripheral direction of a circle centered around the rotational axis of the shaft 31. For example, as shown in FIG. 3, with the ventilation hole 35a as a reference, the flow suppressing parts 51a, 51b are positioned at the angle α, and the air-liquid boundaries A1, A2 between the air A region and the lubricant 34 region are positioned at the angle β. In this case, the flow suppressing parts 51a, 51b are initially positioned in the peripheral direction at the time of manufacturing in positions that satisfy the relation (1) shown below.

B<α<90° (1)

Specifically, by positioning the flow suppressing parts 51a, 51b somewhat more towards the outside in the peripheral direction than the air-liquid boundaries A1, A2, movement of the air-liquid boundaries A1, A2 can be restricted by the flow suppressing parts 51a, 51b even when the air A region moves (as described hereinafter) or expands and contracts (expansion/contraction of the lubricant due to increases or decreases in temperature) in the peripheral direction.

As shown in FIGS. 3 and 4, the flow suppressing parts 51a, 51b are positioned at the same distance d from the outside end and inside end in the radial direction, i.e., the substantial center (refer to the dashed line in the drawing) in the radial direction in the lubricant reservoir 50. The radial direction referred to above is the radial direction of a circle centered around the rotational axis of the shaft 31.

Furthermore, the flow suppressing parts 51a, 51b are positioned nearer the ventilation hole 35a, where the gap is larger than the average gap Ave in the axial direction in the lubricant reservoir 50 for functioning also as a tapered seal part, as shown in FIG. 5. FIG. 5 is a sectional view in which the lubricant reservoir 50 shown in FIG. 4 is developed in the peripheral direction along the center line in the radial direction.

In the example shown in FIG. 4, the flow suppressing parts 51a, 51b extend and make contact to the extent that there is no gap with the upper end surface of the sleeve main body part 32a. Secondary effects whereby the sleeve cover 35 is positioned and more strongly attached with respect to the sleeve main body part 32a in the axial direction are thereby obtained through the flow suppressing parts 51a, 51b making contact with the upper end surface of the sleeve main body part 32a when the sleeve cover 35 is attached to the sleeve main body part 32a.

Description of estimated causes for movement of the air-liquid boundaries A1, A2>

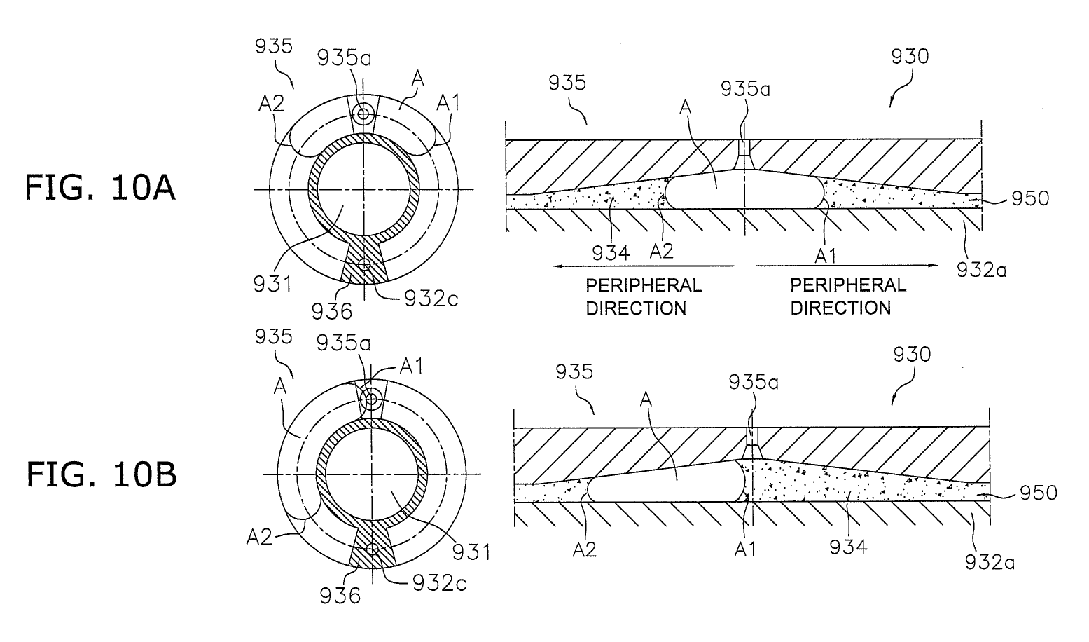

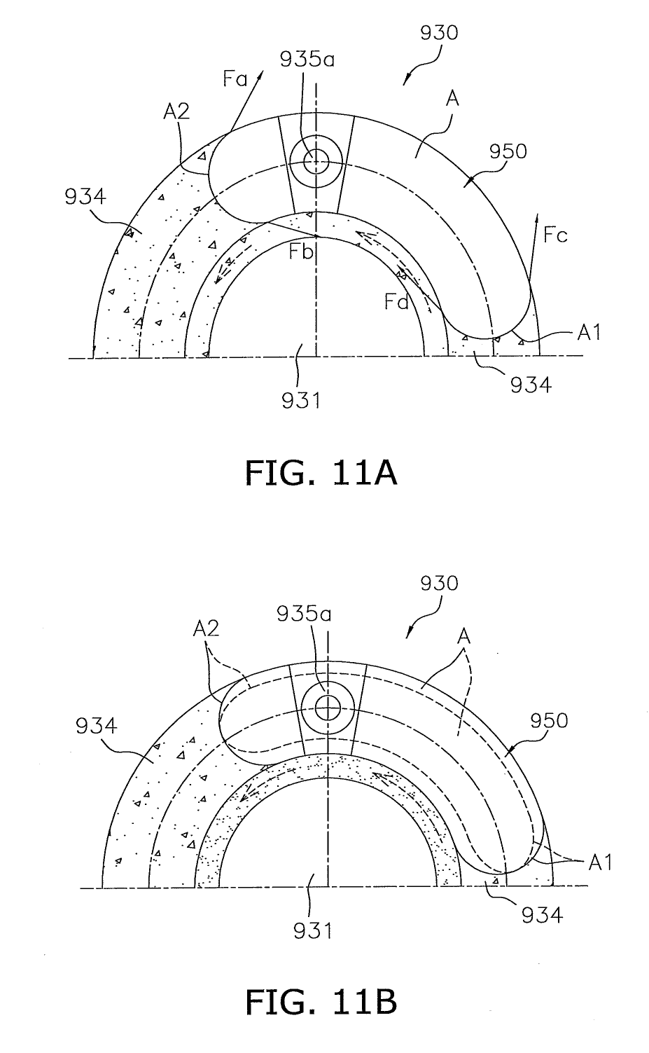

The air-liquid boundaries A1, A2 between the lubricant 934 retained in the lubricant reservoir 950 and the air A around the ventilation hole 935a in a common hydrodynamic bearing device 930 are as described below using FIGS. 10A, 10B, 11A, and 11B. The principles described herein will be described using as an example the structure of a conventional hydrodynamic bearing device 930.

Specifically, FIG. 10A is a plan view and a peripheral-direction development view showing the static state of the hydrodynamic bearing device 930, or a state in which the air A region has not moved in the peripheral direction from the position directly below the ventilation hole 935a.

In this arrangement, the gap in the axial direction of the lubricant reservoir 950 as the tapered seal part decreases in size with moving away from the ventilation hole 935a in the peripheral direction, as shown in FIG. 10A. In this state, surface tension thus acts on the lubricant 934 equally to the left and right in the peripheral direction from the ventilation hole 935a. The air A region is therefore in a state of equal spreading to the left and right of the ventilation hole 935a.

In this state, when the hydrodynamic bearing device 930 begins to rotate, and the lubricant 934 begins to be circulated, the lubricant 934 that rises from the communication hole moves to the minimum gap part 936 (refer to the tilted lines in the plan view on the left of FIG. 10) around the bearing hole and evenly circulates within the bearing gap.

FIG. 10B shows a state in which the air A region has moved significantly in the peripheral direction from the position directly below the ventilation hole 935a during operation of the hydrodynamic bearing device 930.

Such movement of the air A region in the peripheral direction may be caused by fluctuation or the like of the size of the axial-direction gap of the minimum gap part 936 in the peripheral direction. In other words, it is possible that when there are localized portions in which the gap is larger, those portions have less flow channel resistance than the surrounding area, and the flow of the lubricant 934 therefore becomes more concentrated. The direction of this movement does not necessarily coincide with the rotation direction of the bearing.

In other words, when the air A region moves significantly counterclockwise in the peripheral direction, the gas-liquid boundary surface A1 moves near the position directly below the ventilation hole 935a, as shown in FIG. 10B. When shock, vibration, or the like is imparted to the hydrodynamic bearing device 930 in this state, there is a risk of the lubricant 934 near the gas-liquid boundary surface A1 leaking to the outside from the ventilation hole 935a.

Such a phenomenon is as described below using the surface tensions Fa, Fb, Fc, and Fd (see FIG. 11A) that act near the air-liquid boundaries A1, A2.

Specifically, flow occurs in the lubricant 934 inside the lubricant reservoir 950, and the components of the surface tensions Fa, Fb near the gas-liquid boundary surface A1 and the components of the surface tensions Fc, Fd near the gas-liquid boundary surface A2 along the wall surfaces as shown in FIG. 11A each work against the force that causes the air-liquid boundaries A1, A2 between the air A region and the lubricant 934 region to move in the peripheral direction. However, it is difficult for the surface tensions Fa through Fd alone to suppress the force whereby the air-liquid boundaries A1, A2 tend to move in the peripheral direction.

Furthermore, in addition to cases in which the air A region moves in the peripheral direction, there are also cases in which the air A region extends in the axial direction and contracts in the radial direction as shown in FIG. 11B (see dotted line in FIG. 11B). Since the air A region separates from the inner and outer peripheral wall surfaces of the lubricant reservoir 950 in such cases, the surface area of the gas-liquid boundary surfaces of the lubricant 934 significantly increases, and makes contact with the outside air via the ventilation hole 935a. There is thus a risk of increased evaporation of the lubricant 934 and the necessary quantity of the lubricant 934 becoming impossible to maintain, and of no longer being able to extend the service life of the hydrodynamic bearing device 930 that was increased through the use of the structure (see Patent Document 1) in which the lubricant is retained between the sleeve and the sleeve cover.

In the hydrodynamic bearing device 30 of the present embodiment, measures such as described above are naturally put in place so that the air region positioned directly below the ventilation hole does not move in the peripheral direction inside the lubricant reservoir, or so that the air region does not contract in the radial direction.

<Principle by which Movement of the Air-Liquid Boundaries A1, A2 is Suppressed by the Flow Suppressing Parts 51a, 51b>

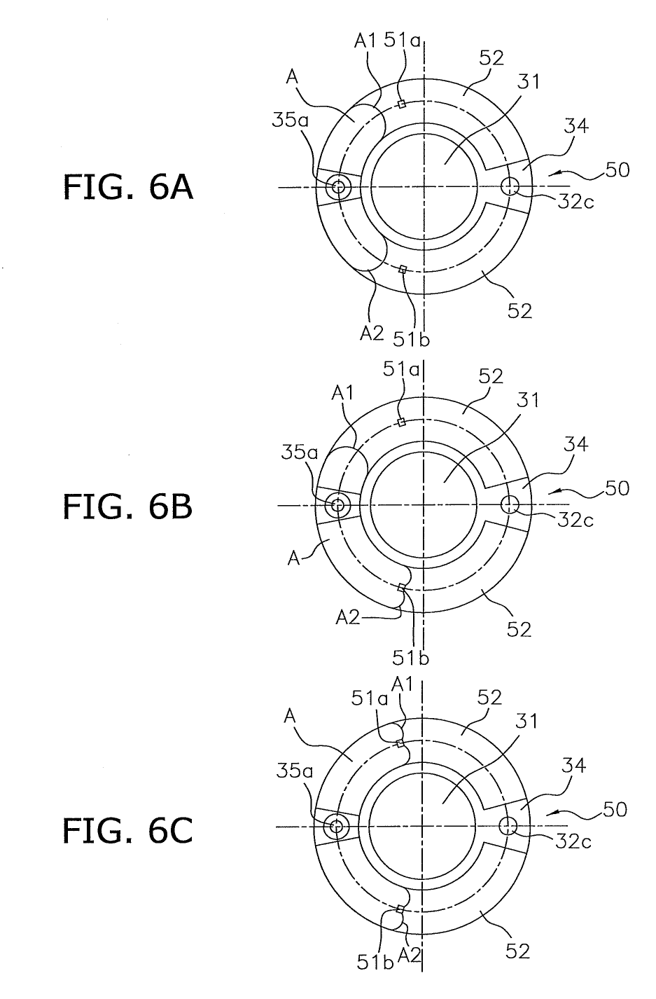

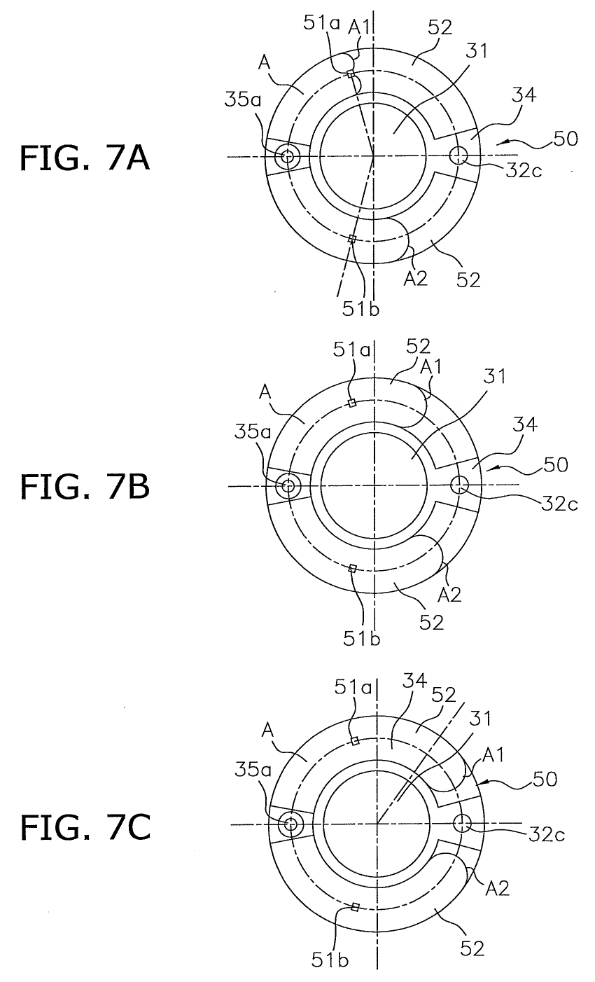

The phenomenon by which movement of the air-liquid boundaries A1, A2 in the peripheral direction is restricted by the flow suppressing parts 51a, 51b in the hydrodynamic bearing device 30 configured as described above is as described below using FIGS. 6A through 6C, and FIGS. 7A through 7C.

FIG. 6A shows a state in which an adequate amount of the lubricant 34 is retained in the lubricant reservoir 50, and the air A region (air area A) is positioned nearly uniformly on the left and right of the ventilation hole 35a in the hydrodynamic bearing device 30 of the present embodiment. In the hydrodynamic bearing device 30, a region of air A of a certain size is preferably formed inside the lubricant reservoir 50 even in the initial state out of consideration for the effects of vibration shock or thermal expansion of the lubricant 34.

In the hydrodynamic bearing device 30 of the present embodiment, the flow suppressing parts 51a, 51b are provided near the approximate center in the radial direction inside the lubricant reservoir 50. The flow suppressing parts 51a, 51b are also formed along the entire gap in the axial direction of the lubricant reservoir 50 (in other words, the flow suppressing parts 51a, 51b are in contact with the upper end surface of the sleeve 32).

In such a configuration as shown in FIG. 6B, when the air A region moves counterclockwise in the peripheral direction during operation of the hydrodynamic bearing device 30, further movement of the gas-liquid boundary surface A2 is suppressed by the flow suppressing part 51b formed in the position of angle α in a narrower range than the angle β of both ends of the air A region. As a result, the gas-liquid boundary surface A1 on the side opposite from the gas-liquid boundary surface A2 whose movement is suppressed by the flow suppressing part 51b can be prevented from moving to near the position directly below the ventilation hole 35a.

FIG. 6C shows a state in which the air A region is enlarged to the extent that the air-liquid boundaries A1, A2 move to near the flow suppressing parts 51a, 51b due to a reduction of the lubricant 34 retained in the lubricant reservoir 50.

In such a state, since the air-liquid boundaries A1, A2 have already reached the flow suppressing parts 51a, 51b, movement of the air A region in the peripheral direction can be suppressed by the surface tension acting in the vicinity of the flow suppressing parts 51a, 51b. In a case such as this as well, the air-liquid boundaries A1, A2 whose movement in the peripheral direction is suppressed by the flow suppressing parts 51a, 51b can thus be prevented from moving to near the position directly below the ventilation hole 35a.

FIG. 7A shows a state in which the amount of the lubricant 34 in the lubricant reservoir 50 is further reduced, and the air A region has further increased in size to the extent that one gas-liquid boundary surface A2 has moved to a position past one flow suppressing part 51b.

In such a state, one gas-liquid boundary surface A1 catches on one flow suppressing part 51a, and the gas-liquid boundary surface A2 on the opposite side can be prevented from moving to the position directly below the ventilation hole 35a.

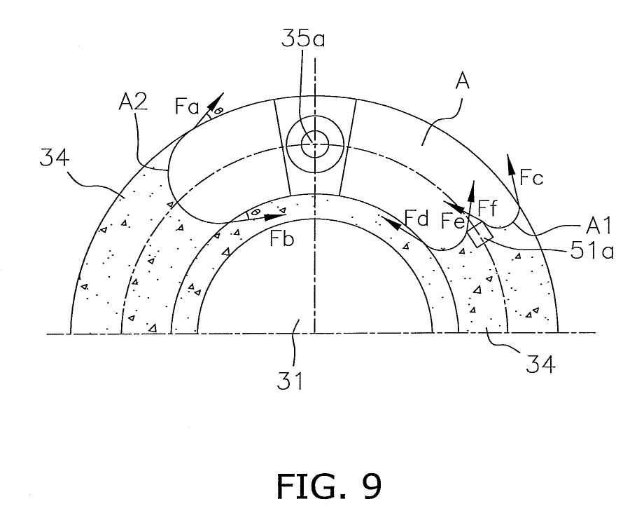

The operation described above will be described in accordance with the principles described below using FIG. 9.

In FIG. 9, Fa and Fb act on the gas-liquid boundary surface A2. In the state in which the gas-liquid boundary surface A1 has moved to the vicinity of the flow suppressing part 51a, the surface tension forces Fc, Fd corresponding to Fa, Fb described above, as well as the surface tension forces Fe, Ff acting on the flow suppressing part 51a, act on the lubricant 34 near the flow suppressing part 51a.

When the flow suppressing part 51a is an angled cylinder as shown in FIG. 9, the contact angles of the angled cylinder walls are considered to be about the same as the contact angles at the side walls of the lubricant reservoir 50. The force received by the lubricant in the peripheral direction is thus as indicated below.

Fc cos θ+Fd cos θ+Fe cos θ+Ff cos θ

On the other hand, the force received by the lubricant in the peripheral direction when the flow suppressing part 51a is not present is as indicated below.

Fa cos θ+Fb cos θ

In this case, θ is the contact angle between the lubricant and the contacting wall surface. In general terms, Fa and Fb are forces acting on the side walls of the lubricant reservoir 50 in the same manner as Fc and Fd, and there is no significant difference. When the flow suppressing part 51a is present, the force in the peripheral direction increases by an amount commensurate with Fe cos θ+Ff cos θ. In other words, a relation such as the following is considered to occur.

(Fa cos θ+Fb cos θ)<(Fc cos θ+Fd cos θ+Fe cos θ+Ff cos θ)

Consequently, it is apparent that the force suppressing movement of the lubricant increases when the flow suppressing part 51a is present.

FIGS. 7B and 7C show a state in which the amount of the lubricant 34 in the lubricant reservoir 50 is further reduced, and the air A region is further enlarged to the extent that both of the air-liquid boundaries A1, A2 move to positions that are past both of the flow suppressing parts 51a, 51b.

In such a state, since the air-liquid boundaries A1, A2 have already moved near the communicating hole 32c at the maximum distance from the ventilation hole 35a, the air-liquid boundaries A1, A2 do not move to the position directly below the ventilation hole 35a even when the air A region has moved in the peripheral direction.

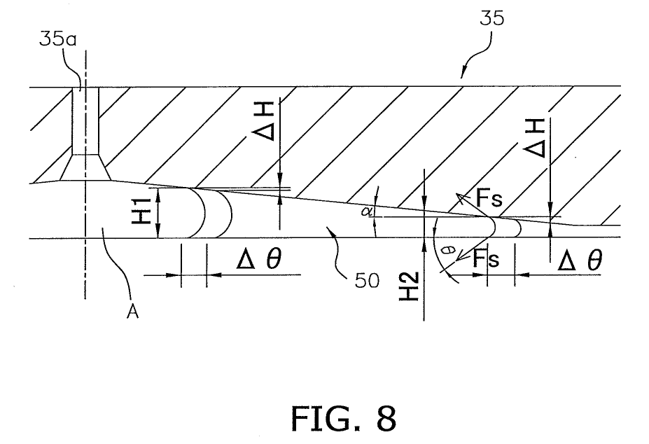

As shown in FIG. 8, since the surface tension of the lubricant 34 increases as the axial-direction gap of the lubricant reservoir 50 decreases, it becomes even more difficult for the air A region to move in the peripheral direction. This can be indicated by the numerical formulas below using the reference symbols shown in FIG. 8. The pressures received by the air-liquid boundaries in the positions H1 and H2 are indicated by P1 and P2, respectively. In this instance, θ is the contact angle between the lubricant and the contacting wall surface, α is the angle at which the axial-direction gap of the lubricant reservoir 50 varies, and Fs is the surface tension force.

$$P 1 = \frac{2 Fs cos ( θ + α / 2 )}{H 1}$$

$$P 2 = \frac{2 Fs cos ( θ + α / 2 )}{H 2}$$

Since H1>H2 in the equations, P2>P1.

It is thereby possible to effectively suppress movement of the air A region further to the inside in the clockwise direction from the flow suppressing part 51a.

[Characteristics of the Hydrodynamic Bearing Device 30]

(1)

As shown in FIGS. 3 through 5 and other drawings, the hydrodynamic bearing device 30 of the present embodiment is provided with the shaft 31; the sleeve 32 in which the shaft 31 is installed so as to be able to rotate in relative fashion; the lubricant 34 filled into a minute gap between the shaft and the sleeve; the sleeve cover 35 attached so as to cover the upper end surface of the sleeve main body part 32a via a gap, the sleeve cover 35 having the ventilation hole 35a for communicating the lubricant 34 with the outside air; and the lubricant reservoir 50 for retaining the lubricant 34 in the gap between the sleeve 32 and the sleeve cover 35. In the present embodiment, the lubricant reservoir 50 formed in the sleeve cover 35 is formed so that the axial-direction gap decreases in size with moving away from the ventilation hole 35a in the peripheral direction, and has the flow suppressing parts 51a, 51b formed so as to protrude in the axial direction.

Movement of the air-liquid boundaries A1, A2, which are the ends of the air A region, to the vicinity of the ventilation hole 35a can thereby be suppressed by the flow suppressing parts 51a, 51b even when the air A region immediately below the ventilation hole 35a formed in the lubricant reservoir 50 moves in the peripheral direction. The amount of leakage of the lubricant 34 from the ventilation hole 35a, or the amount of evaporation of the lubricant 34, is thereby minimized, and reduced product service life or contamination of the inside of the spindle motor 1 can be prevented.

(2)

In the hydrodynamic bearing device 30 of the present embodiment, the flow suppressing parts 51a, 51b provided in order to suppress movement of the air-liquid boundaries A1, A2 in the peripheral direction are members that protrude from the sleeve cover 35 toward the opposing upper end surface of the sleeve main body part 32a, as shown in FIG. 4 and other drawings.

The flow suppressing parts 51a, 51b for suppressing movement of the air-liquid boundaries A1, A2 in the peripheral direction can thereby be formed by a simple structure as a portion of the sleeve cover 35. When the sleeve cover 35 is molded from a resin, integral molding can be used.

(3)

In the hydrodynamic bearing device 30 of the present embodiment, the flow suppressing parts 51a, 51b are positioned on both the left and right sides of the ventilation hole 35a in the peripheral direction of a circle centered around the rotational axis of the shaft 31, as shown in FIG. 3 and other drawings.

Excessive movement of the air-liquid boundaries A1, A2 in the peripheral direction can thereby be stably suppressed by providing the air-liquid boundaries A1, A2 respectively to the both sides of the ventilation hole 35a even when the direction in which the air A region moves in the peripheral direction cannot be specified, for example. As a result, the air-liquid boundaries A1, A2 can be prevented from moving to the position directly below the ventilation hole 35a, and such defects as leakage of the lubricant 34 to the outside can be prevented.

(4)

In the hydrodynamic bearing device 30 of the present embodiment, the flow suppressing parts 51a, 51b are positioned at approximately equal angles to the left and right in the peripheral direction from the ventilation hole 35a, as shown in FIG. 3 and other drawings.

Even when it is impossible to identify the movement direction and the like of the air A region due to the rotation direction of the hydrodynamic bearing device 30, the size of the axial-direction gap of the lubricant reservoir 50, and various other conditions, movement of the air-liquid boundaries A1, A2 in the peripheral direction can be stably suppressed by the flow suppressing parts 51a, 51b placed at equal angles on the left and right.

(5)

In the hydrodynamic bearing device 30 of the present embodiment, the flow suppressing parts 51a, 51b are positioned in the approximate center portion in the radial direction in the lubricant reservoir 50, as shown in FIG. 3 and other drawings.

The approximate center of the front of the air-liquid boundaries A1, A2 can thereby be held back by the flow suppressing parts 51a, 51b during rotation of the hydrodynamic bearing device 30 even when the air A region moves or extends in the peripheral direction, for example. As a result, movement of the air-liquid boundaries A1, A2 in the peripheral direction can be most effectively suppressed regardless of the shape or other characteristics of the air A region.

(6)

In the hydrodynamic bearing device 30 of the present embodiment, the flow suppressing parts 51a, 51b are formed in positions in which the gap is larger than the average gap Ave in the axial direction in the lubricant reservoir 50, as shown in FIG. 5.

Movement of the air-liquid boundaries A1, A2 in the peripheral direction can thereby be even more effectively suppressed by the flow suppressing parts 51a, 51b positioned in the portions of the large gap where the air-liquid boundaries A1, A2 (air A) move relatively easily. Movement of any one of the air-liquid boundaries A1, A2 to the position directly below the ventilation hole 35a is thereby prevented, and the lubricant 34 can be prevented from leaking out from the ventilation hole 35a.

(7)

In the hydrodynamic bearing device 30 of the present embodiment, the flow suppressing parts 51a, 51b are formed without a gap in the axial direction in the gap between the sleeve cover 35 and the upper end surface of the sleeve main body part 32a, as shown in FIG. 4 and other drawings.

The air-liquid boundaries A1, A2 can thereby be held back by the flow suppressing parts 51a, 51b in the entire region in the axial direction even when the air A region moves or extends in the peripheral direction. As a result, movement of the air-liquid boundaries A1, A2 in the peripheral direction can be most effectively suppressed regardless of the shape or other characteristics of the air A region.

Since contact is made with the upper end surface of the sleeve main body part 32a when the sleeve cover 35 is attached to the sleeve main body part 32a, secondary effects are obtained whereby the sleeve cover 35 is positioned and more strongly attached with respect to the sleeve main body part 32a in the axial direction.

(8)

The spindle motor 1 of the present embodiment is provided with the hydrodynamic bearing device 30 described above, the hub 11, the rotor magnet 12, and the stator core 23 onto which the coil 22 is wound, as shown in FIG. 1 and other drawings.

The amount of leakage of the lubricant 34 from the ventilation hole 35a, or the amount of evaporation of the lubricant 34 is thereby minimized, reduced product service life, contamination of the inside of the spindle motor 1 can be prevented, and other effects as described above can be obtained.

### Embodiment 2

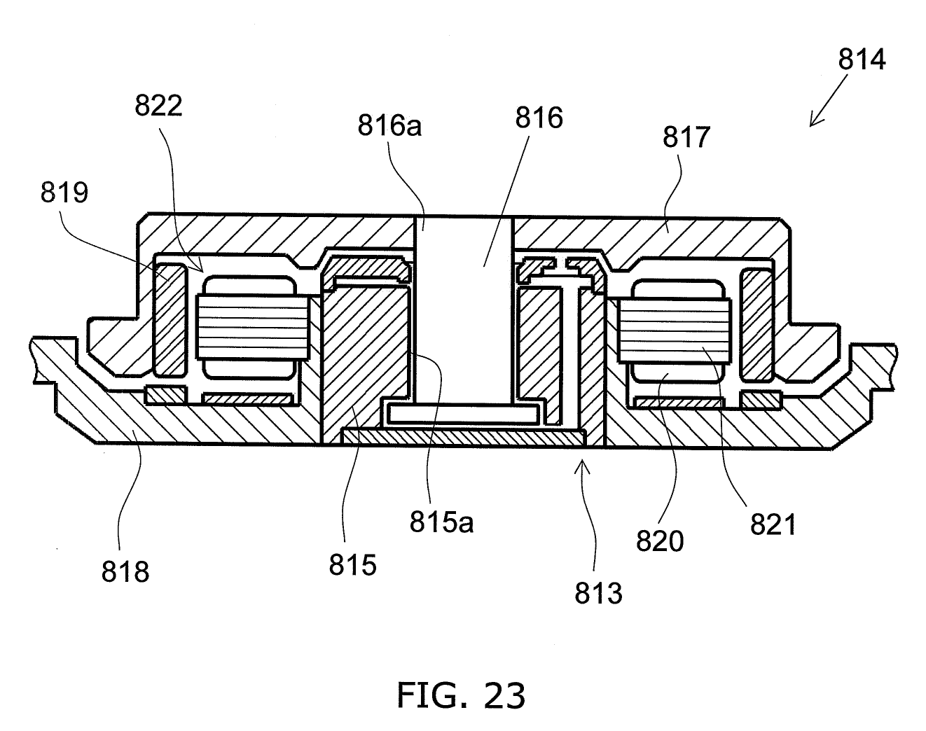

FIG. 23 is a sectional view showing a spindle motor 814 provided with the hydrodynamic bearing device 813 in Embodiment 2 of the present invention.

For the sake of convenience in the description below, a case will be described in which the open end of the bearing hole 815a of the sleeve 815 is positioned upward, and the closed end is positioned downward, but this positioning is not limited during actual use.

As shown in FIG. 23, a substantially inverted-cup-shaped hub 817 as a rotary member to which a magnetic recording disk, for example, is fixed on the external periphery thereof is press-fit onto a circular pillar-shaped protruding shaft part 816a that protrudes from a circular bearing hole 815a of a cylindrical sleeve 815 in a shaft 816, and a rotor magnet 819 is attached to the internal periphery of a cylindrical downward-hanging wall part formed on the external periphery of the hub 817. A stator core 821 on which a stator coil 820 is wound is also attached to a base 818 to which the hydrodynamic bearing device 813 is fixed, so as to face the rotor magnet 819 in the radial direction on the internal peripheral side of the rotor magnet 819. A rotational drive unit 822 of the spindle motor 814 for imparting rotational drive force between the shaft 816 and the sleeve 815 is formed by the rotor magnet 819 and the stator core 821.

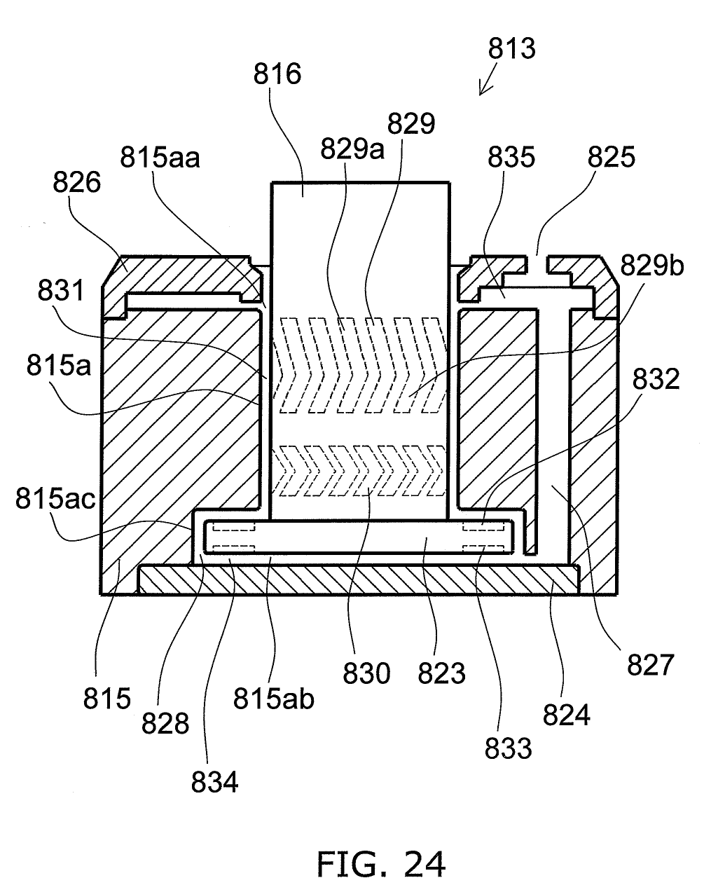

The hydrodynamic bearing device 813 will next be described using FIG. 24. FIG. 24 is a sectional view of the hydrodynamic bearing device 813. The hydrodynamic bearing device 813 is composed of the shaft 816, the sleeve 815, a thrust flange 823, a thrust plate 824, and a sleeve cover 826; the sleeve 815 is fixed to a base 818 of the spindle motor 814 as shown in FIG. 23, and as shown in FIG. 24, the sleeve 815 has a the bearing hole 815a having an open end 815aa on the open upper side of the sleeve 815 and a closed end 815ab on the closed lower side, and the round pillar-shaped shaft 816 is inserted in an orientation that allows rotation via a gap.

The thrust flange 823 is a round plate-shaped component having a larger diameter than the shaft 816, is fixed by a screw or fitting onto the lower end part of the shaft 816, and is positioned in an orientation in the large-diameter hole part 815ac that is the closed-end side in the bearing hole 815a so as to form a gap with respect to the upper surface of the large-diameter hole part 815ac.

The thrust plate 824 is a round plate-shaped component that is larger than the bearing hole 815a of the sleeve 815, and is fixed to the bottom part of the sleeve 815 so as to face the lower surface of the thrust flange 823 via a gap.

Furthermore, the sleeve cover 826 has a circular hole that is fitted via a gap from the shaft 816, an inclined surface that spreads toward the outside in the radial direction from the central axis of rotation of the shaft 816 is formed in the internal peripheral surface of the sleeve cover 826, and the sleeve cover 826 covers the upper end surface (end surface on the open-end side) of the sleeve 815 in a state in which a gap is formed, and has a single ventilation hole 825 for communicating the gap with the outside air. The material of the sleeve cover 826 is a translucent material in order to facilitate confirmation of the interface of the lubricant 828 when the lubricant 828 described hereinafter is filled in. The abovementioned inclined surface may be provided on the shaft side or on both the shaft and sleeve cover sides.

In this hydrodynamic bearing device 813, a single communicating hole 827 (the diameter thereof being about 0.2 mm to 0.6 mm, for example) is formed parallel to the central axis of rotation in a location near the external peripheral surface in the sleeve 815, and the communicating hole 827 communicates the large-diameter hole part 815ac (gap region on the side of the closed-end surface) provided on the side of the closed end 815ab of the bearing hole 815a, and the gap region between the sleeve cover 826 and the upper end surface that is the end surface on the side of the open end 815aa of the sleeve 815.

The lubricant 828 is filled into the space inside the sleeve 815 that includes the space between the sleeve cover 826 and the sleeve 815 (i.e., the space between the external peripheral surface of the shaft 816 and the internal peripheral surface of the sleeve 815; the space inside the large-diameter hole part 815ac of the bearing hole 815a; the space of the location of communication between the communicating hole 827 and the large-diameter hole part 815ac of the bearing hole 815a; the space inside the communicating hole 827; and the space between the sleeve cover 826 and the upper end surface of the sleeve 815 (except for the location of the ventilation hole 825)).

Hydrodynamic grooves 829, 830 having a herringbone pattern or other pattern are formed vertically on the internal peripheral surface of the sleeve 815 (or on the external peripheral surface of the shaft 816 or on both the internal peripheral surface of the sleeve 815 and the external peripheral surface of the shaft 816). A radial hydrodynamic bearing 831 is formed in which the shaft 816 and the sleeve 815 are supported so as to be able to rotate via a predetermined gap in the radial direction through the force of the lubricant 828 that is scraped out by the hydrodynamic grooves 829, 830 when the shaft 816 and the sleeve 815 are rotated relative to each other by the rotational drive force described above.

Hydrodynamic grooves 832, 833 having a spiral shape or other shape are formed on the upper surface and lower surface of the thrust flange 823 (or on the opposing lower surface of the sleeve 815, the upper surface of the thrust plate 824, or on all surfaces that include the upper and lower surfaces of the thrust flange 823, the lower surface of the sleeve 815, and the upper surface of the thrust plate 824), and a thrust hydrodynamic bearing 834 is formed in which the shaft 816 and the sleeve 815 are rotatably supported via a predetermined gap in the thrust direction (axial direction) by the force of the lubricant 828 scraped out by the hydrodynamic grooves 832, 833 when the sleeve 815 and the thrust flange 823 attached to the shaft 816 are rotated relative to each other by the rotational drive force or the like described above.

In this arrangement, the hydrodynamic grooves 829, 830 constituting the radial hydrodynamic bearing 831 have a publicly known herringbone shape, and are formed in two locations on the upper side and lower side on the external peripheral surface of the shaft 816. In the lower hydrodynamic grooves 830, the grooves ascending at an angle from the vertex and the grooves descending at an angle from the vertex each have the same length. The upper hydrodynamic grooves 829 are formed so that the grooves 829a ascending at an angle from the vertex are longer than the grooves 829b descending at an angle from the vertex. During rotational driving, the operating fluid 828 in the gap is actively sent downward by the upper hydrodynamic grooves 829.

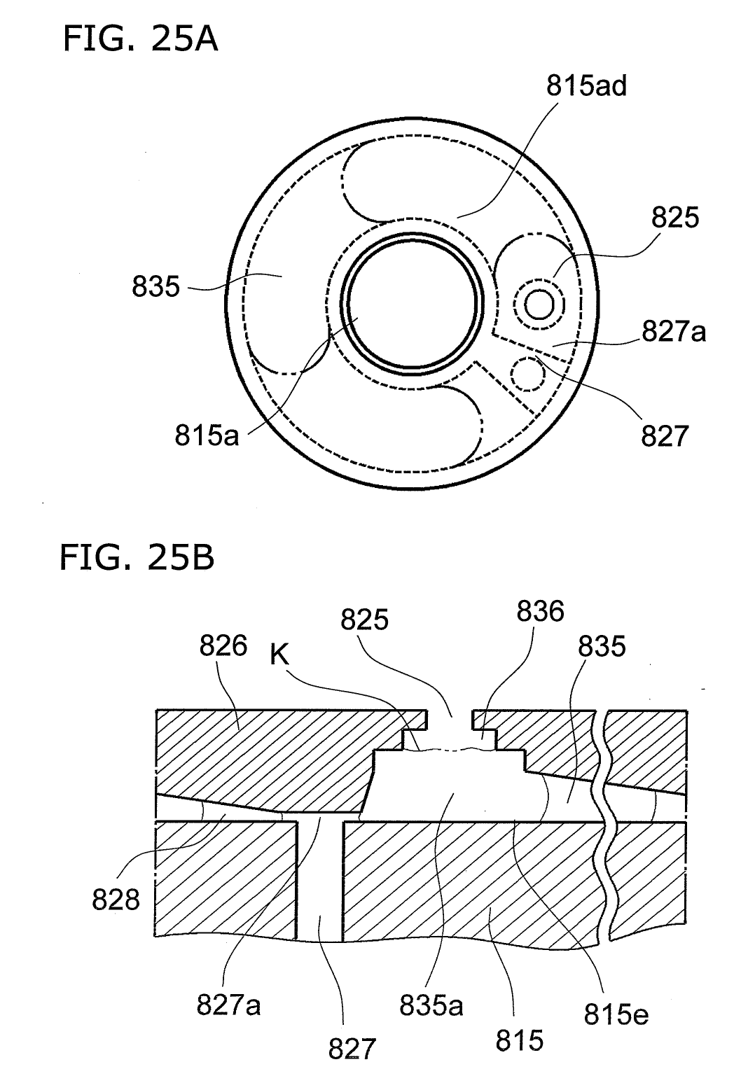

In the hydrodynamic bearing device 813 thus configured, the space (hereinafter referred to as the lubricant reservoir 835) into which the lubricant 828 is filled and which is formed by the sleeve cover 826 and the upper end surface on the side of the open end 815aa of the sleeve 815 has the function of storing the lubricant against reduction of the lubricant 828 due to evaporation or the like. The structure thereof will be described using FIGS. 25A and 25B.

FIG. 25A is a diagram showing the lubricant reservoir 835 as viewed from the side of the open end 815aa of the sleeve 815. FIG. 25B is a developed schematic diagram showing the lubricant reservoir 835.

As shown in FIGS. 25A and 25B, the upper end surface 815e in the sleeve 815 opposite the sleeve cover 826 is formed so as to be approximately flat. The shape of the back surface portion of the sleeve cover 826 opposite the upper end surface 815e is such that the distance between the sleeve 815 and the upper end surface 815e causes capillary action to occur in the introduction gap 827a in the vicinity of the open part of the communicating hole 827 that opens to the upper end surface 815e of the sleeve 815, and in the region 815ad of the external periphery in the vicinity of the open end of the bearing hole 815a of the sleeve 815, and the lubricant 828 is drawn into the bearing hole 815a in the internal peripheral surface of the sleeve 815 by capillary action. The introduction gap 827a is also formed so as to continue to the open end of the bearing hole 815a of the sleeve 815 via the region 815ad.

In the introduction gap 827a and the region 815ad herein, the separation gap formed between the back surface portion of the sleeve cover 826 and the upper end surface 815e of the sleeve 815 is 0.03 mm to 0.15 mm, for example, and is constant in the radial direction in the present embodiment.

The shape of the back surface part of the sleeve cover 826 is depressed so that a larger space is formed in the introduction gap 827a and the locations other than the region 815ad than in the separation gap formed between the upper end surface 815e of the sleeve 815 and the back surface part of the sleeve cover 826 in the introduction gap 827a and the region 815ad, and the lubricant reservoir 835 is formed so as be able to reserve the lubricant 828 and the lubricant reservoir 835 communicates the introduction gap 827a and the ventilation hole 825 in the peripheral direction.

The lubricant reservoir 835 herein has an inner diameter of about 3.2 mm to 3.8 mm, an outer diameter of about 5.5 to 6.3 mm, a minimum gap of about 0.03 mm to 0.15 mm, and a maximum gap of about 0.2 mm to 0.3 mm, for example.

The ventilation hole 825 has a diameter of about 0.2 mm to 1.0 mm, for example, and a recess portion 836 (having a diameter of about 0.6 mm to 1.0 mm and a depth of about 0.1 mm to 0.3 mm, for example) as a buffer space formed by a countersink hole having a larger diameter than the ventilation hole 825 is formed concentrically with the ventilation hole 825 around the ventilation hole 825 in the back surface part of the sleeve cover 826.

The separation distance to the upper end surface 815e of the sleeve 815 is greatest at the location (referred to as the maximum space part 835a) of the lubricant reservoir 835 connected to the ventilation hole 825 and the recess portion 836, and the lubricant reservoir 835 is formed in a shape in which the back surface of the bar 826 for forming the lubricant reservoir 835 is tilted with respect to the peripheral direction so that the separation distance from the upper end surface 815e (end surface on the side of the open end) of the sleeve 815 increases toward the maximum space part 835a from the introduction gap 827a.

In the present embodiment, the separation gap of the lubricant reservoir 835 is constant with respect to the radial direction, and the ventilation hole 825 for communicating to the outside air is provided in a position at an angle of approximately 15 degrees from the open part of the communicating hole 827 in the sleeve cover 826 as viewed in a plane. However, this configuration is not limiting, and insofar as the configuration of the sleeve cover 826 described above is possible, it is apparent that a smaller angle enables the peripheral-direction distance of the lubricant reservoir 835 to be increased, and for the lubricant to be maintained in the bearing gap for a longer period of time.

Since the recess portion 836 is formed in the ventilation hole 825, the interface K of the lubricant 828 stays in the recess portion 836, and the lubricant 828 does not leak to the outside from the ventilation hole 825 even when the temperature of the environment in which the hydrodynamic bearing device 813 is placed increases in a state in which the maximum amount of the lubricant 828 is present.

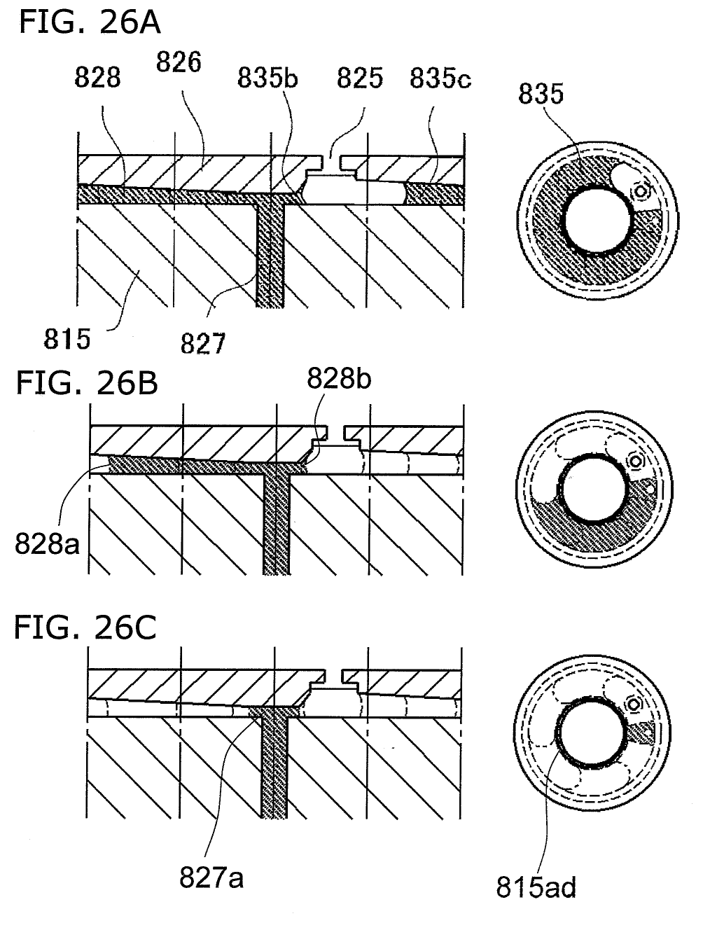

Variations of the interface that accompany evaporation of the lubricant 828 in the lubricant reservoir 835 configured as described above will next be described using FIGS. 26A through 26C. FIG. 26A shows a state prior to evaporation of the lubricant 828 of the lubricant reservoir 835, and FIG. 26B shows a state in which half of the lubricant 828 of the lubricant reservoir 835 has evaporated. FIG. 26C shows a state in which the lubricant 828 of the lubricant reservoir 835 has almost completely evaporated.

When the lubricant 828 evaporates from the state shown in FIG. 26A, the interface of the lubricant 828 positioned in the ventilation hole 825 moves, and the interface moves to the left and right of the lubricant reservoir 835 in FIG. 26A. However, the space 835b formed between the ventilation hole 825 and the communicating hole 827 is formed so that the cross-sectional area (the cross-sectional area of the lubricant reservoir 835 when the lubricant reservoir 835 is viewed from the peripheral direction in FIG. 25A is referred to as the space cross-sectional area) of the interface in the lubricant reservoir 835 is rapidly varied by the inclined surface formed in the back surface portion of the sleeve cover 826. On the other hand, the other space 835c is formed so that the cross-sectional area of the interface in the lubricant reservoir 835 gradually varies.

Since evaporation of the lubricant 828 is affected by the cross-sectional area of the interface, the space 835b having an rapidly varying cross-sectional area and the space 835c having a gradually varying cross-sectional area are present in the lubricant reservoir 835 as previously described. Therefore, the amount of movement of the interfaces 828a, 828b of the lubricant 828 is greater on the side of the space 835c, as shown in FIG. 26B.

As shown in FIG. 26C, when the lubricant 828 of the lubricant reservoir 835 is completely evaporated, a state occurs in which the lubricant 828 remains in the introduction gap 827a in the vicinity of the open part of the communicating hole 827, and in the region 815ad on the external periphery of the vicinity of the open end of the bearing hole 815a shown in FIG. 25 that is provided to the sleeve 815.

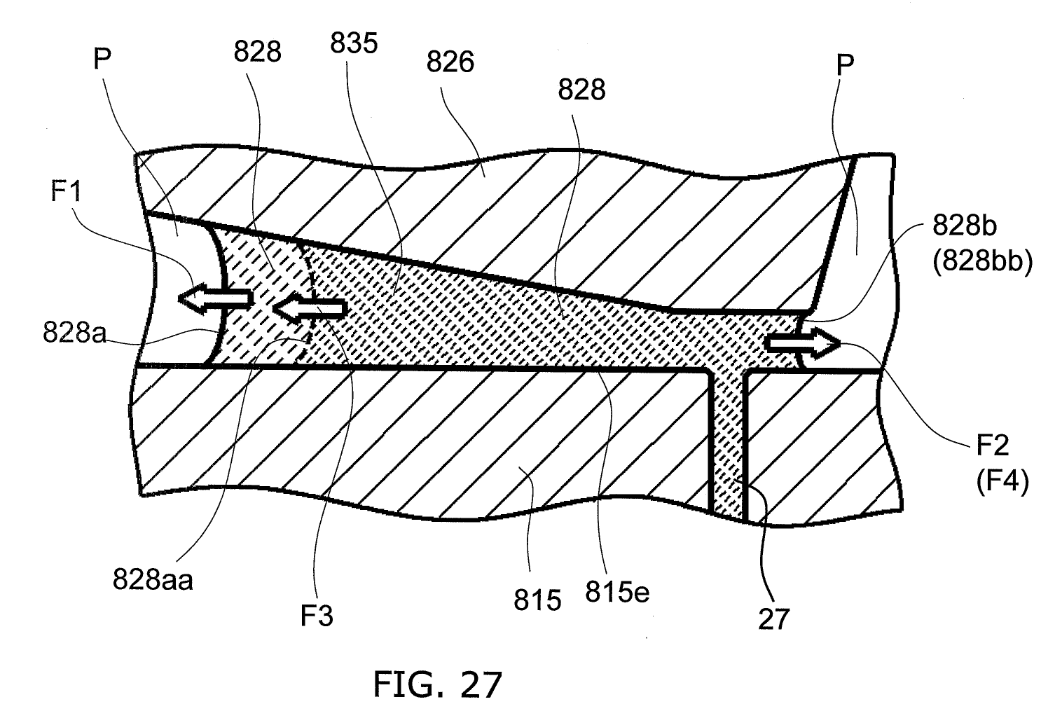

As described above, the interface moves due to evaporation of the lubricant 828, but the fact that the interface moves to the left and right in the lubricant reservoir 835 will be furthermore described using FIG. 27.

FIG. 27 is a simplified diagram showing the state of the interface (surface at which the atmosphere contacts the lubricant 828) of the lubricant 828 in the lubricant reservoir 835 formed by the upper end surface 815e of the sleeve 815 and the sleeve cover 826 that is positioned opposite the upper end surface 815e.

The lubricant 828 is filled into the lubricant reservoir 835 by a publicly known technique of vacuum oiling or the like, but the lubricant 828 evaporates as time elapses. As a result, the interface 828a and interface 828b such as shown in FIG. 27 occur while the surface tension force of the lubricant 828, the surface area of the interface in contact with the atmosphere, and the atmospheric pressure P achieve equilibrium. This equilibrium state will be described.

In the lubricant reservoir 835, the surface tension F1 of the lubricant 828 acts on the interface 828a in the direction of the atmospheric pressure P from the lubricant 828. The surface tension F1 and the atmospheric pressure P inside the lubricant reservoir 835 are in equilibrium, and satisfy (formula 1). In the same manner, the surface tension 2 also acts on the interface 828b, is in equilibrium with the atmospheric pressure P inside the lubricant reservoir 835, and satisfies (formula 2).

F1/Aa=Pa (formula 1)

F2/Ab=Pb (formula 2)

Pa=Pb=P (formula 3)

Aa: surface area of the interface 828a in contact with the atmosphere

Ab: surface area of the interface 828b in contact with the atmosphere

In other words, according to formula (3) above, equilibrium occurs in the state of the interfaces 828a, 828b shown in FIG. 26, and the lubricant 828 does not leak to the outside.

The state of the interface when the lubricant 828 further evaporates from the state described above will next be described. The interface 828a will first be described. Through evaporation of the lubricant 828, the interface 828a moves to the interface 828aa as shown in FIG. 27. The relationship of the surface tension F3 at the interface 828aa, the surface area of the interface in contact with the atmosphere, and the atmospheric pressure P in the lubricant reservoir 835 satisfies formula (4). The interface 828b also moves to the interface 828bb in the same manner, and the relationship of the surface tension F4 at the interface 828bb, the surface area of the interface in contact with the atmosphere, and the atmospheric pressure P in the lubricant reservoir 835 satisfies formula (5).

F3/Aaa=Paa (formula 4)

F4/Abb=Pbb (formula 5)

Paa=Pbb=P (formula 6)

Aaa: surface area of the interface 828aa in contact with the atmosphere

Abb: surface area of the interface 828bb in contact with the atmosphere

In other words, the interfaces move while the interfaces of the lubricant 828 are always maintained in a state of equilibrium with the atmospheric pressure P, as indicated by formula (3) and formula (4).

However, since the surface areas of the interfaces that are in contact with the atmosphere are almost the same in the interface 828b and the interface 828bb, and the surface areas of the interfaces that are in contact with the atmosphere are small compared to that of the interface 828a (interface 828aa), Ab≈Abb, and as a result, F2/Ab≈F4/Abb. In other words, the interface 828b is positioned in almost the same position even when the lubricant 828 evaporates.

The interface thus moves in one direction (direction toward the communicating hole 827 from the direction of the interface 828a in FIG. 27) as the lubricant 828 evaporates.

In other words, the space 835b functions as a flow suppressing part for suppressing the interfaces 828a, 828b of the lubricant 828.

In the present embodiment, an inclined surface having a tilt angle of 5 degrees is provided to the back surface portion of the sleeve cover 826 in which the interface 828a is formed, and an inclined surface having a tilt angle of 50 degrees is provided to the back surface portion of the sleeve cover 826 in which the interface 828b is formed, so that the relations described above are satisfied.

The interfaces move in one direction as previously described if the tilt angles of the inclined surfaces provided to the back surface portion of the sleeve cover 826 in which the two interfaces (828a, 828b) are formed are in a ratio of 2× or higher. The effects can be even more significantly obtained by making the ratio preferably 10× or higher.

According to the present embodiment, since the distance in the peripheral direction of the lubricant reservoir 835 formed by the sleeve cover 826 and the upper end surface 815e of the sleeve 815 can be increased, the lubricant 828 can be maintained for a longer period of time.

Furthermore, in two different interfaces 828a, 828b of the lubricant 828 retained in the fluid retaining space (space 835b) formed by the sleeve cover 826 for covering the upper end surface 815e on the side of the open part of the sleeve 815, each of the interfaces 828a, 828b moves a different amount over time due to evaporation and the like, and the lubricant 828 can thereby be maintained in the bearing gap for a long period of time.

### Embodiment 3

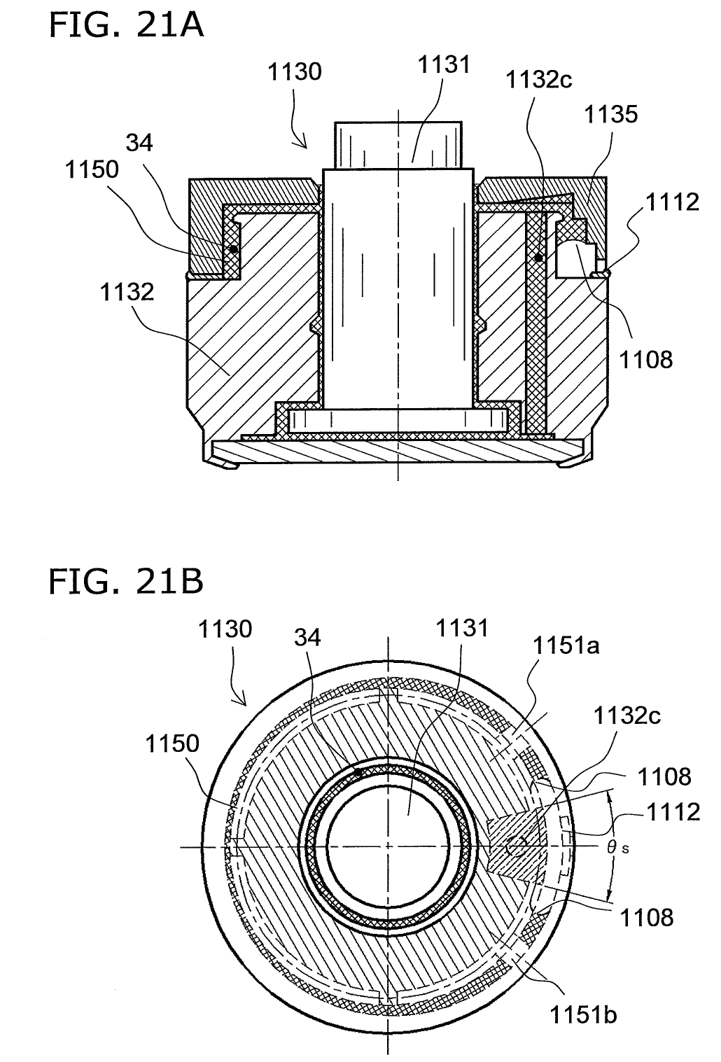

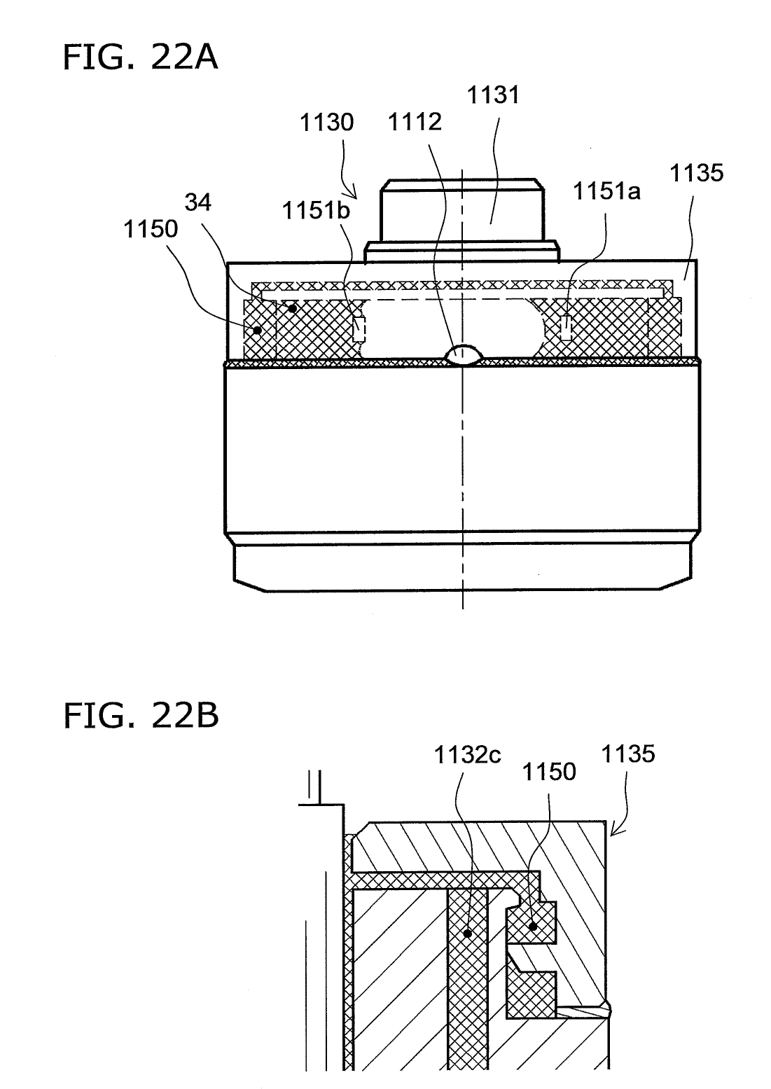

The hydrodynamic bearing device 1130 according to yet another embodiment of the present invention is as described hereinafter using FIGS. 21A through 22B.

The hydrodynamic bearing device 1130 of the present embodiment as shown in FIGS. 21(a) and 21(b) differs from the hydrodynamic bearing device 30 of Embodiment 1 in that a substantially cylindrical lubricant reservoir 1150 is provided in the gap between the external peripheral surface of the sleeve 1132 and the internal peripheral surface of the sleeve cover 1135 as well, and the surface on the external peripheral side of the sleeve cover 1135 has a ventilation hole 1112. In other words, the lubricant reservoir 50 of Embodiment 1 described above is formed in the gap between the inner surface of the sleeve cover 35 and the upper end surface of the sleeve 32 opposing in the axial direction. The lubricant reservoir 1150 of the present embodiment, however, is formed in the gap between the internal peripheral surface of the sleeve cover 1135 and the external peripheral surface of the sleeve 1132 opposing in the radial direction.

The hydrodynamic bearing device 1130 of the present embodiment also has the flow suppressing parts 1151a, 1151b shown in FIGS. 21B and 22A, instead of the flow suppressing parts 51a, 51b of Embodiment 1 described above.

The lubricant reservoir 1150 is a substantially toric gap portion, and is formed so that the gap in the radial direction decreases in size as the distance from the ventilation hole 1112 in the peripheral direction increases. In other words, in the lubricant reservoir 1150, the gap in the radial direction has a maximum size in a position near the ventilation hole 1112, and the gap in the radial direction has a minimum size in a position on the opposite side farthest distant from the ventilation hole 1112.

The flow suppressing parts 1151a, 1151b protrude in the radial direction from the internal peripheral surface of the sleeve cover 1135, as shown in FIG. 22B, and suppress movement of the interface 1108 of the lubricant 34 retained in the lubricant reservoir 1150. The flow suppressing parts 1151a, 1151b are also positioned symmetrically at nearly the same interval with the ventilation hole 1112 in the center thereof, and restrict movement in the peripheral direction of the two interfaces 1108 that are in the vicinity of the ventilation hole 1112. Furthermore, as shown in FIG. 22B, the flow suppressing parts 1151a, 1151b are positioned so that portions thereof come in contact with the external peripheral surface of the sleeve 1132 from the internal peripheral surface of the sleeve cover 1135.

The flow suppressing parts 1151a, 1151b may also be formed so as to protrude in the radial direction from the external peripheral surface of the sleeve 1132 rather than from the internal peripheral surface of the sleeve cover 1135.

Movement of the interface 1108 of the lubricant 34 in the peripheral direction can thus be suppressed when shock, vibration, or the like is imparted from the outside, even in a configuration such as one in which the flow suppressing parts 1151a, 1151b protrude in the radial direction.

The amount of leakage of the lubricant 34 from the ventilation hole 1112, or the amount of evaporation of the lubricant 34 is thereby minimized, and reduced product service life or contamination of the inside of the spindle motor can be prevented.

The effects described in (1) through (8) of Embodiment 1 can be obtained in the same manner by the hydrodynamic bearing device 1130 of the present embodiment.

### Other Embodiments

An embodiment of the present invention was described above, but the present invention is not limited to the embodiments described above, and various modifications thereof are possible within the intended scope of the invention.

(A)

In embodiments 1 and 3, examples were described in which the flow suppressing parts 51a, 51b and the flow suppressing parts 1151a, 1151b were provided one each on the left and right of the ventilation holes 35a, 1112 formed in the sleeve covers 35, 1135. However, the present invention is not limited by this configuration.

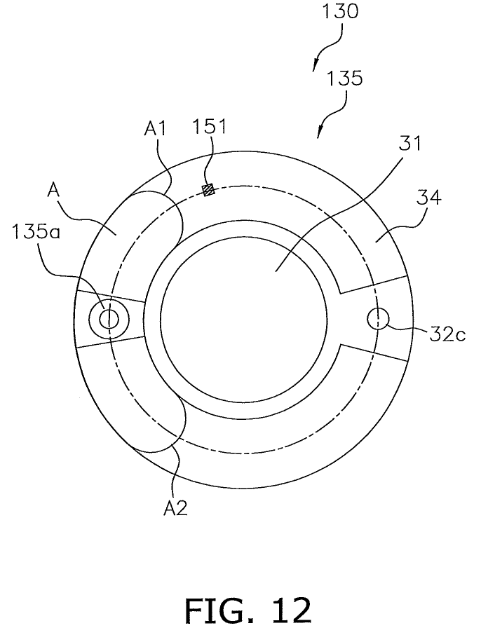

For example, a hydrodynamic bearing device 130 may be configured as shown in FIG. 12, in which a flow suppressing part 151 is provided on any one of the left and right of the ventilation hole 135a of the sleeve cover 135.

In this case, the position of the single flow suppressing part with respect to the ventilation hole is preferably set according to various conditions that specify the direction in which the air area moves, such as the rotation direction of the rotary member side, the gap size of the fluid reservoir, fluctuation of the gap, and other conditions (in other words, this configuration can be used when the movement direction of the air region can be specified).

Movement of the gas-liquid boundary surfaces to the position directly below the ventilation hole can thereby be reliably suppressed even when only one flow suppressing part is provided.

(B)

In Embodiments 1 and 3, examples were described in which the flow suppressing parts 51a, 51b and the flow suppressing parts 1151a, 1151b were provided one each at nearly equal angles to the left and right of the ventilation holes 35a, 1112 formed in the sleeve covers 35, 1135. However, the present invention is not limited by this configuration.

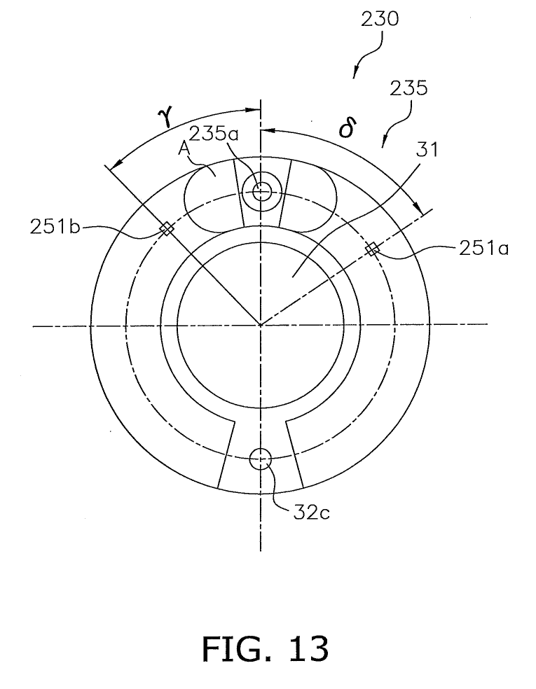

For example, a hydrodynamic bearing device 230 may be configured as shown in FIG. 13, in which flow suppressing parts 251a, 251b are positioned at unequal angles γ and δ to the left and right of the ventilation hole.

(C)

In Embodiments 1 and 3, examples were described in which the flow suppressing parts 51a, 51b and the flow suppressing parts 1151a, 1151b were provided one each on the left and right of the ventilation holes 35a, 1112 formed in the sleeve covers 35, 1135. However, the present invention is not limited by this configuration.

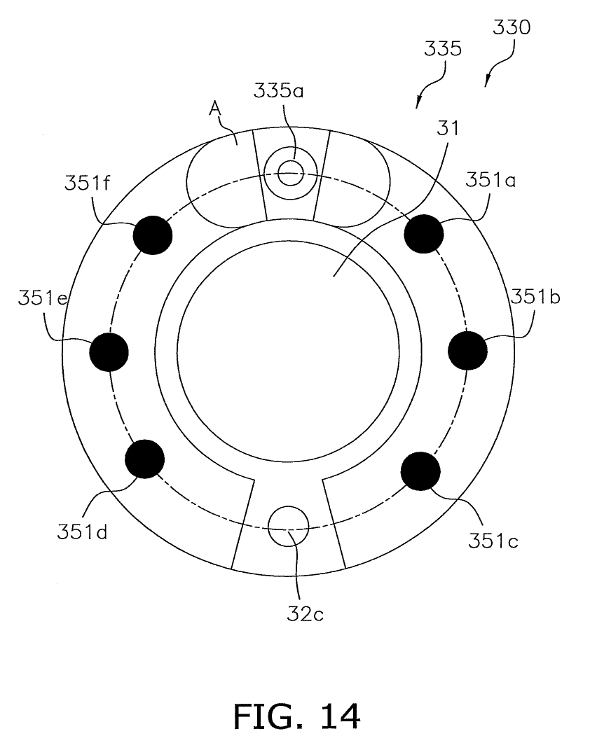

For example, a hydrodynamic bearing device 330 may be configured as shown in FIG. 14, in which a plurality of flow suppressing parts 351a through 351f is positioned on the left and right of a ventilation hole 335a.

In this case, movement of the gas-liquid boundary surfaces can be suppressed through a number of layers by the plurality of flow suppressing parts regardless of whether the gas-liquid boundary surfaces moves to the left or the right of the ventilation hole.

Furthermore, since contact is made with the upper end surface of the sleeve main body part 32a when the sleeve cover 35 is attached to the sleeve main body part 32a, secondary effects are obtained whereby the sleeve cover 35 is positioned and more strongly attached with respect to the sleeve main body part 32a in the axial direction.

Besides the rectangular column shape such as described in the embodiments, the flow suppressing parts may also have a circular pillar shape as shown in FIG. 14, and it is sufficient insofar as the shape generates new surface tension forces such as the surface tension forces Fe and Ff described above.

(D)

In Embodiments 1 and 3, examples were described in which the flow suppressing parts 51a, 51b and the flow suppressing parts 1151a, 1151b were formed without a gap in the entire area in the axial direction or the radial direction. However, the present invention is not limited by this configuration.

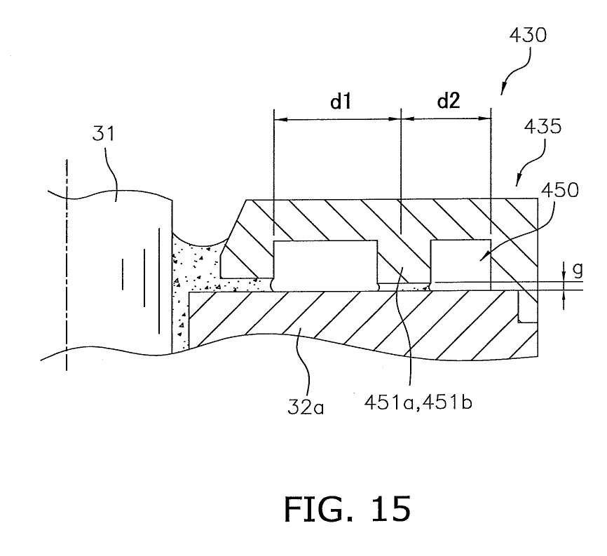

For example, a hydrodynamic bearing device 430 may be configured as shown in FIG. 15, in which flow suppressing parts 451a, 451b that protrude from the upper end surface of the sleeve main body part 32a or the surface opposite the upper end surface are provided so that a minute gap g is formed in the axial direction.

(E)

In Embodiments 1 and 3, examples were described in which the flow suppressing parts 51a, 51b and the flow suppressing parts 1151a, 1151b were positioned in the approximate center portion in the radial direction and axial direction of the lubricant reservoirs 50, 1150. However, the present invention is not limited by this configuration.

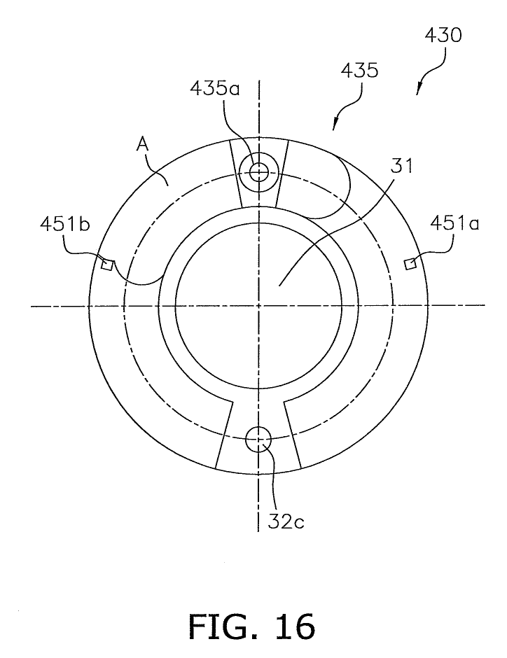

For example, a hydrodynamic bearing device 430 may be configured as shown in FIGS. 15 and 16, in which flow suppressing parts 451a, 451b are positioned somewhat toward the outside (distance d1>distance d2) in the radial direction within the lubricant reservoir 450.

In general, the pressure on the internal peripheral side tends to increase more readily than on the external peripheral side in the lubricant reservoir. Therefore, movement of the gas-liquid boundary surfaces can be reliably suppressed in the position at which a pressure balance occurs by providing the flow suppressing parts toward the outside in the radial direction.

In contrast to the configuration described above, the flow suppressing parts may also be provided somewhat toward the inside in the radial direction.

(F)

In Embodiment 1, an example was described in which convex parts that protrude toward the upper end surface of the sleeve main body part 32a from the sleeve cover 35 were used as the flow suppressing parts 51a, 51b. However, the present invention is not limited by this configuration.

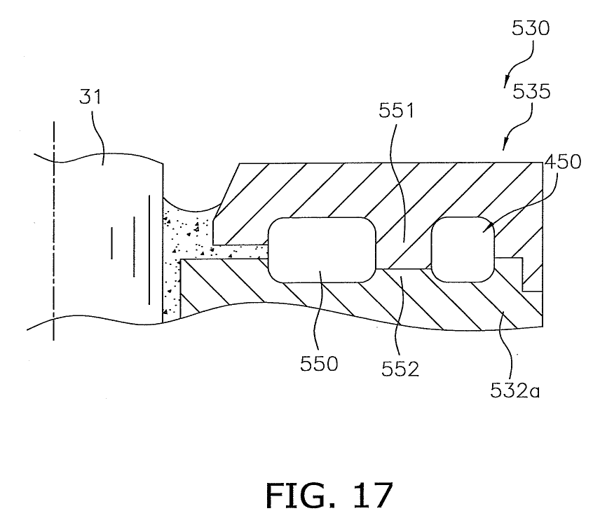

For example, a hydrodynamic bearing device 530 may be configured as shown in FIG. 17, in which a combination of a convex part 551 that protrudes toward the opposing sleeve main body part 532a from the sleeve cover 535, and a convex part 552 that protrudes toward the opposing sleeve cover 535 from the upper end surface of the sleeve main body part 532a is used as the flow suppressing part.

As shown in FIG. 17, the lubricant reservoir 450 as well as the lubricant reservoir 550 may be formed in the sleeve main body part 532a. It is also sufficient, of course, to have only the lubricant reservoir 550. The bottom surface of the sleeve cover 535 can be made flat in this case.

(G)

In Embodiment 1, an example was described in which convex parts that protrude toward the upper end surface of the sleeve main body part 32a from the sleeve cover 35 were used as the flow suppressing parts 51a, 51b. However, the present invention is not limited by this configuration.

For example, the flow suppressing parts may be formed by convex parts that protrude toward the sleeve cover from the upper end surface of the sleeve. There may also be a convex part that protrudes toward the upper end surface of the sleeve main body part 32a from the sleeve cover 35, and a convex part that protrudes toward the sleeve cover from the upper end surface of the sleeve.

(H)

In Embodiments 1 and 3, examples were described in which pillar-shaped members were used as the flow suppressing parts 51a, 51b and the flow suppressing parts 1151a, 1151b. However, the present invention is not limited by this configuration.

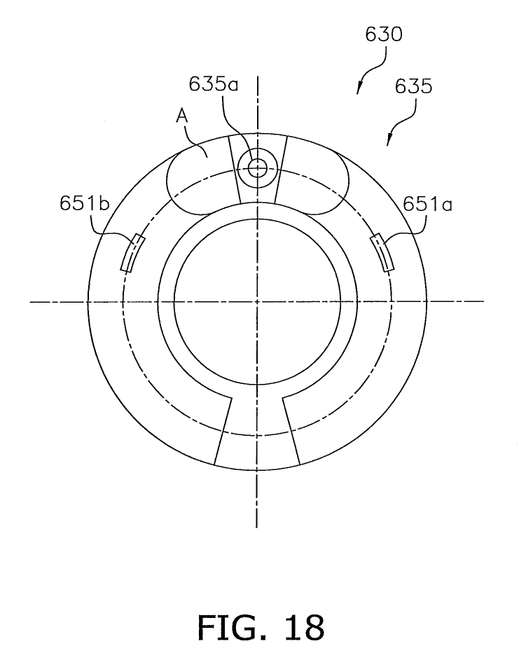

For example, rather than pillar-shaped members as the flow suppressing parts, a hydrodynamic bearing device 630 may be configured as shown in FIG. 18, in which a sleeve cover 635 is used that is provided with block-shaped members 651a, 651b formed in the peripheral direction about the ventilation hole 635a.

In this case, the range of increase of the surface tension force applied to the lubricant is increased by block-shaped members that elongate in the peripheral direction, and movement of the air-liquid boundaries can be more reliably suppressed.

(I)

In Embodiments 1 and 3, examples were described in which the sizes of the gaps between the sleeve covers 35, 1135 and the opposing sleeve main body part 32a and sleeve 1132 for forming the lubricant reservoirs 50, 1150 varied in the peripheral direction about the rotational axis of the shaft 31. However, the present invention is not limited by this configuration.

For example, it is possible to adopt a configuration such as one in which the size of the gap between the sleeve cover and the opposing sleeve main body part varies in the radial direction about the rotational axis of the shaft, rather than in the peripheral direction.

(J)

In Embodiments 1 and 3, examples were described in which the flow suppressing parts 51a, 51b and the flow suppressing parts 1151a, 1151b were provided on the side of the gap that is larger than the average gap Ave of the gap in the axial direction, in the peripheral direction of the lubricant reservoirs 50, 1150 in which the tapered seal part is formed, but the present invention is not limited by this configuration.

For example, the flow suppressing parts can also be placed in positions in which the gap is less than the average gap.

(K)

A spindle motor 1 in which the hydrodynamic bearing device 30 of the present invention was mounted was described as an example in Embodiment 1. However, the present invention is not limited by this configuration.

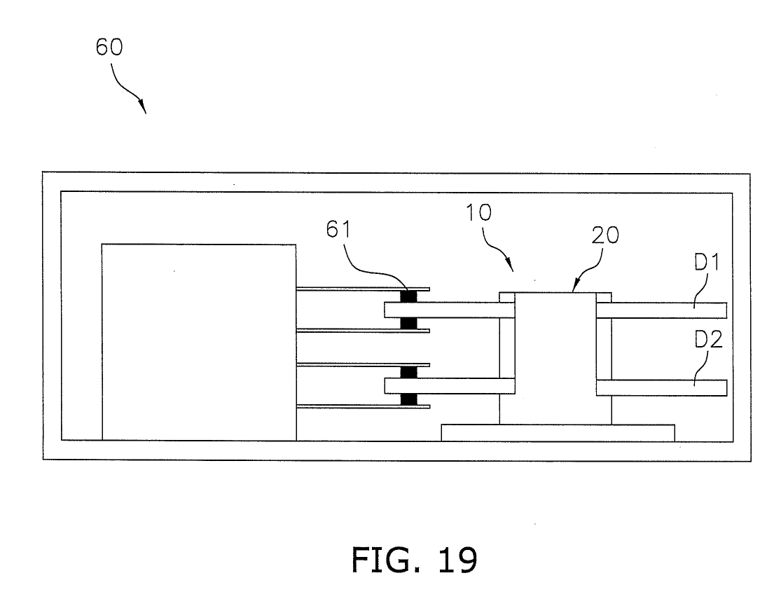

For example, the present invention may also be applied to a magnetic recording and reproducing apparatus (information apparatus) 60 in which are mounted a plurality of recording disks D1, D2, and a spindle motor 1 that includes the hydrodynamic bearing device 30, as shown in FIG. 19.

In this case, the spindle motor 1 that includes the hydrodynamic bearing device 30 is mounted in a magnetic recording and reproducing apparatus 60 that has a recording head (head part) 61, whereby leakage of the lubricant from the ventilation hole is effectively suppressed, and it is possible to obtain a device having a long service life, in which there is minimal contamination of the inside of the device.

Devices in which the hydrodynamic bearing device of the present invention is mounted are not limited to a magnetic recording and reproducing device, and it is apparent that the hydrodynamic bearing device of the present invention can also be mounted in optical disk and other recording and reproducing devices, laser scanners and other information apparatuses for driving a polygon mirror, and CPU cooling fan motors and the like for notebook personal computers and the like.

(L)

The present invention is not limited by Embodiment 2 described above, and various modifications of the present invention are possible within the intended scope of the invention.

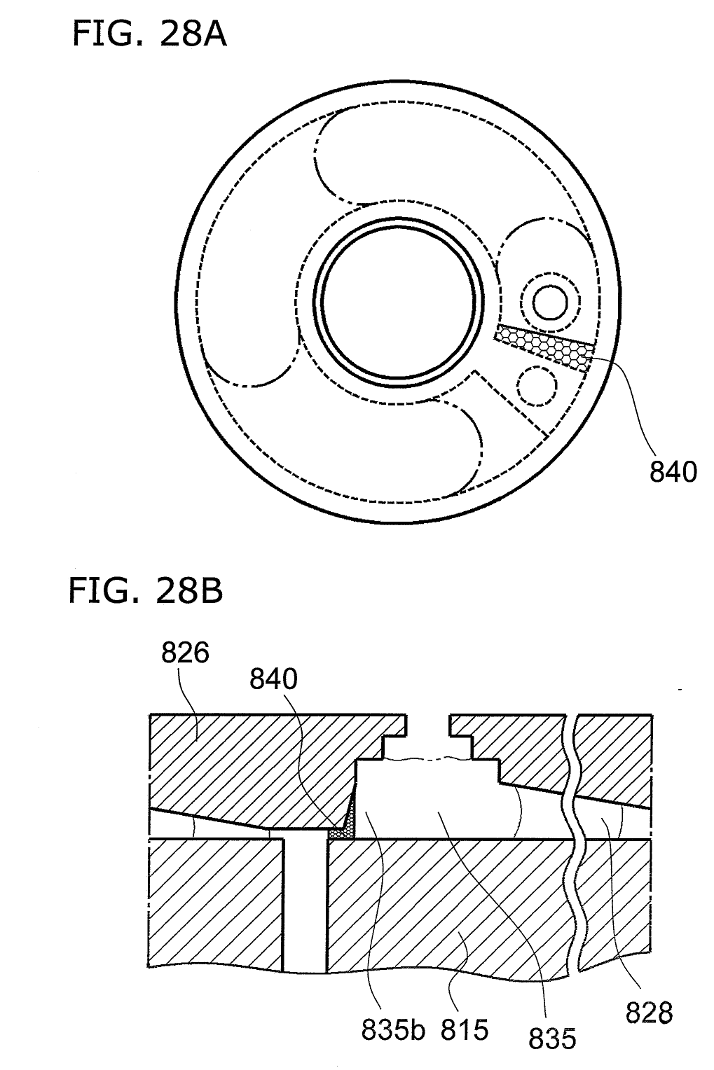

For example, as shown in FIGS. 28A and 28B, a configuration may be adopted in which the space 835b formed so that the cross-sectional area of the lubricant reservoir 835 in the peripheral direction rapidly varies is blocked by a blocking member 840. By sealing the space 835b by the blocking member 840, the interface of the lubricant 828 of the lubricant reservoir 835 moves only in the limited peripheral direction, and the lubricant 828 can be maintained for a longer period of time. The blocking member 840 may be separate from both or integrally formed with one of the sleeve cover 826 and the sleeve 815.

### INDUSTRIAL APPLICABILITY

The hydrodynamic bearing device of the present invention demonstrates effects whereby the lubricant is prevented from leaking out from the ventilation hole even when vibration or shock is imparted to the hydrodynamic bearing device, and defects such as reduced service life due to outside contamination or inadequate lubricant in the hydrodynamic bearing device can be prevented from occurring. The present invention can therefore be widely applied to hydrodynamic bearing devices that employ a structure in which a lubricant reservoir is provided to the upper end surface of the sleeve, and to disk driving devices, rotating head drum driving devices, polygon mirror driving devices, and other spindle motors in which the hydrodynamic bearing device is mounted.

What is claimed is:

1. A hydrodynamic bearing device comprising:
a shaft;
a sleeve having a bearing hole through which the shaft is inserted so as to be able to rotate relative to the sleeve;
a lubricant filled into a gap between at least the shaft and the sleeve;
a sleeve cover through which the shaft is inserted so as to protrude, the sleeve cover being attached so as to cover an end surface on one side of the sleeve in an axial direction via a gap, and having a ventilation hole for communicating the lubricant with outside air;
a lubricant reservoir for retaining the lubricant between the sleeve and the sleeve cover; and
a flow suppressing part formed inside the lubricant reservoir so as to suppress movement of the lubricant in a peripheral direction.

2. The hydrodynamic bearing device according to claim 1, wherein the lubricant reservoir is formed in a gap in the axial direction between the sleeve and the sleeve cover, and the flow suppressing part is formed so as to protrude in substantially the axial direction.

3. The hydrodynamic bearing device according to claim 1, wherein the lubricant reservoir is formed in a gap in a radial direction between an internal peripheral surface of the sleeve cover and an external peripheral surface of the surface on one side of the sleeve, and the flow suppressing part is formed so as to protrude in substantially the radial direction.

4. The hydrodynamic bearing device according to claim 1, wherein the flow suppressing part is formed so as to include a convex part that protrudes toward an opposing surface of the sleeve from the sleeve cover.

5. The hydrodynamic bearing device according to claim 1, wherein the flow suppressing part is formed so as to include a convex part that protrudes toward the opposing sleeve cover from the surface of the sleeve.

6. The hydrodynamic bearing device according to claim 1, wherein the flow suppressing parts are positioned on left and right sides of the ventilation hole in a peripheral direction around the shaft.

7. The hydrodynamic bearing device according to claim 6, wherein the flow suppressing parts positioned on left and right sides of the ventilation hole are positioned at substantially equal angles from the ventilation hole.

8. The hydrodynamic bearing device according to claim 2, wherein the flow suppressing part is positioned in a substantially central portion in the radial direction inside the lubricant reservoir.

9. The hydrodynamic bearing device according to claim 3, wherein the flow suppressing part is positioned in a substantially central portion in the axial direction inside the lubricant reservoir.

10. The hydrodynamic bearing device according to claim 2, wherein the flow suppressing part is formed without a gap in the axial direction in the gap between the sleeve and the sleeve cover.

11. The hydrodynamic bearing device according to claim 3, wherein the flow suppressing part is formed without a gap in the radial direction in the gap between the sleeve and the sleeve cover.

12. The hydrodynamic bearing device according to claim 1, wherein the flow suppressing part includes a block-shaped member extending in the peripheral direction.

13. The hydrodynamic bearing device according to claim 2, wherein the lubricant reservoir is formed so that a gap in the axial direction decreases in the peripheral direction from a maximum size in a vicinity of the ventilation hole.

14. The hydrodynamic bearing device according to claim 3, wherein the lubricant reservoir is formed so that a gap in the radial direction decreases in the peripheral direction from a maximum size in a vicinity of the ventilation hole.

15. The hydrodynamic bearing device according to claim 13, wherein the flow suppressing part is formed in positions in which the gap is larger than an average size of the gap in the axial direction in the lubricant reservoir.

16. The hydrodynamic bearing device according to claim 14, wherein the flow suppressing part is formed in positions in which the gap is larger than an average size of the gap in the radial direction in the lubricant reservoir.

17. The hydrodynamic bearing device according to claim 1, comprising:
a closed end surface disposed at the other end surface in the axial direction of the sleeve;
a first space formed between the sleeve cover and the end surface on one side of the sleeve;
a second space on the side of the closed end surface inside the bearing hole in the sleeve;
a communicating channel for communicating the first space and the second space, the communicating channel being formed in the sleeve;
a radial bearing formed between an external peripheral surface of the shaft and an internal peripheral surface of the sleeve; and
an introduction gap formed from a vicinity of an open part of the communicating channel to an open end of the bearing hole in the first space; wherein
the lubricant reservoir is formed so that a cross-sectional area of the first space gradually decreases in size in the peripheral direction from the ventilation hole to the open part of the communicating channel; and
the flow suppressing part is positioned on an opposite side in the peripheral direction from the lubricant reservoir so as to sandwich the ventilation hole, and is formed so as to rapidly reduce a size of the cross-sectional area of the first space in the peripheral direction from the ventilation hole to the open part of the communicating channel.

18. A hydrodynamic bearing device comprising:
a sleeve having a bearing hole that has an open end and a closed end;
a shaft inserted in a state of being able to rotate via a gap inside the bearing hole;
a sleeve cover attached so as to cover the end surface on the open end side of the sleeve;
a first space formed between the sleeve cover and the end surface on the side of the open end;
a second space on the side of the closed end surface inside the bearing hole in the sleeve;
a communicating channel for communicating the first space and the second space, the communicating channel being formed in the sleeve;
a lubricant filled into a gap between the sleeve cover, the sleeve, and the shaft;
a radial bearing formed between an external peripheral surface of the shaft and an internal peripheral surface of the sleeve;
a thrust bearing formed between an end surface inside the closed end of the sleeve and the end surface of the shaft on the side facing the closed end of the sleeve;
an introduction gap formed from a vicinity of the open part of the communicating channel to an open end of the bearing hole in the first space;
a ventilation hole for communicating the first space with outside air, the ventilation hole being formed in the sleeve cover;
a first lubricant reservoir in which a cross-sectional area of the first space gradually decreases in size in the peripheral direction toward the open part of the communicating channel from the ventilation hole; and
a second lubricant reservoir in which a cross-sectional area of the first space rapidly decreases in size in the peripheral direction toward the open part of the communicating channel from the ventilation hole, the second lubricant reservoir being positioned on an opposite side in the peripheral direction from the first lubricant reservoir via the ventilation hole.

19. The hydrodynamic bearing device according to claim 18, wherein
the first lubricant reservoir and the second lubricant reservoir are formed by an inclined surface provided to the sleeve cover or the end surface of the sleeve on the side facing the open end;
the inclined surface for forming the first lubricant reservoir has a tilt angle of 5 to 7 degrees in the peripheral direction; and
the inclined surface for forming the second lubricant reservoir has a tilt angle of 50 to 70 degrees in the peripheral direction.

20. The hydrodynamic bearing device according to claim 18, wherein a blocking part for blocking a flow of the lubricant in the peripheral direction from the ventilation hole to the vicinity of the open part of the communicating channel is formed in the second lubricant reservoir.

21. A spindle motor comprising:
the hydrodynamic bearing device according to claim 1;
a hub attached to a rotation side of the hydrodynamic bearing device;
a rotary magnet attached to the hub; and
a stator coil for imparting rotational force to the rotary magnet.

22. An information apparatus comprising:
the spindle motor according to claim 21; and
a head part for performing recording and reproducing of a recording disk that is rotationally driven by the spindle motor.

23. A spindle motor comprising:
the hydrodynamic bearing device according to claim 18;
a hub attached to a rotation side of the hydrodynamic bearing device;
a rotary magnet attached to the hub; and
a stator coil for imparting rotational force to the rotary magnet.

24. An information apparatus comprising:
the spindle motor according to claim 23; and
a head part for performing recording and reproducing of a recording disk that is rotationally driven by the spindle motor.
